(19) United States
(12) Patent Application Publication
(10) Pub. No.: US 2015/0227522 A1
(43) Pub. Date: Aug. 13, 2015

(54) METHOD AND SYSTEM FOR SELECTION OF A MEDIA FILE BASED ON A RESPONSE

(71) Applicant: ChaCha Search, Inc, Carmel, IN (US)

(72) Inventors: Eugene M. O'Donnell, Indianapolis, IN (US); Scott A. Jones, Carmel, IN (US); Vee Lee, Carmel, IN (US)

(21) Appl. No.: 14/617,027

(22) Filed: Feb. 9, 2015

Related U.S. Application Data
(60) Provisional application No. 61/936,975, filed on Feb. 7, 2014.
(60) Provisional application No. 61/941,291, filed on Feb. 18, 2014.

(51) Int. Cl. G06F 17/30

(52) U.S. Cl. CPC G06F 17/3053; G06F 17/30112; G06F 17/30864

(57) ABSTRACT

A system and method of choosing media which may be presented in conjunction with a posting is described. Content of a question or request is analyzed to generate query which is used to obtain a media file which matches the query. A response or reply or answer to a request and any information associated with a posting may be used to select and/or rank a media file which may be made available.

### BACKGROUND

1. Field of the Invention

The present invention is related to selection of media to be presented and particularly to selection of media to be presented in conjunction with postings.

2. Description of the Related Art

In many types of applications a user may wish to express an idea in media such as audio, images, and/or video rather than or in addition to textual media. In systems such as the Twitter® or Instagram® media sharing systems, a user may elect to share an image by attaching a picture obtained from local storage of a user device to a message which is uploaded to a service. Such a message may be referred to as a post.

However, such systems may have significant limitations. Generally images on a user device may not be well organized and it may be difficult for a user to locate a relevant image easily. In addition, a user may not have a relevant image, video or audio clip accessible from a user device. As a consequence use of richer media in messaging or postings may be handicapped. Images may be located using facilities such as an image search engine which may index images from a large number of websites. However, a user may be required to create a query, select an image, examine rights associated with the image, etc. Such a process may take an excessive amount of time and again may discourage use of rich media in casual postings.

Current systems may have further troubles due to a lack of an efficient means for performing a search of media files. Media search engines are intended to receive queries directed to a particular keyword and/or other metadata of an image. However, it may be difficult to determine an image which a user will find interesting based on text of a posting. A user may include text which is unrelated to an object of a search and/or may refer to a prior or parallel posting which may determine and/or qualify a target of a media file search. Similarly, rankings of media files may be adversely affected as there is a lack of reliable data of actual usage of an image in a particular context. For example, a user may download a file based on a query, but may elect to use a different file after various considerations which cannot be detected by a conventional search ranking.

For these and other reasons a system for selection of a media file based on a response would be greatly appreciated

### SUMMARY

A system is implemented whereby a user may submit a posting and may receive information of a posting and provide a response. A posting may consist of a statement or question and/or media. A reply is associated with a posting and may include any suitable type of media. A posting may be submitted by a user to a server device which may store and/or distribute a posting to a destination. A user may be able to provide a response and/or may receive information of a posting and/or a response to a posting.

If a user elects to include a media file in a posting and/or a response a search facility may be provided. A search query may be created based on content of a post and/or a response. A search query may be created based on keywords of a response, which may be selected based on a ranking of keywords. A ranking of keywords may be created based on frequency of usage, inverse usage frequency and/or other statistical data obtained from a corpus. For example, usage of keywords in postings and/or responses may affect a selection and ranking of keywords used to create a query based on content of a request. A search facility may include a display of indicators of media files in an order based on a ranking of the media files. If a media file is selected it may be presented in conjunction with a response of a user. Presentation of a media file in conjunction with a response may affect a ranking of a media file for content of a query which was used to select a media file. Similarly, activities by other users relating to a response associated with a media file such as an image and/or video may affect a ranking of a media file for metadata, content, and/or other information used to select a media file.

A search facility may present possible queries created based on content of a response. For example, if a keyword is a highest ranking keyword of a query the keyword may be presented in a list of probable or suggested search queries for selection of a media file. A ranking of a media file for a response may be affected by a source of a post to which the response is targeted. A ranking of a media file may be based on metadata associated with a response. For example, if a number of media files have been associated with responses to a posting, metadata associated with media files of the responses may affect a query and/or a ranking of a media file associated with a response. A category may be assigned to a post based on content of a post and/or responses to a post. A media file may be selected and/or ranked based on a category and/or content of a request.

A ranking of a media file may be modified based on selections of media files to be posted with a response and/or posting. For example, if a media file is presented as a highest ranking media file and a different media file is selected to be provided in conjunction with a post and/or response a ranking of the media file may be reduced for future queries associated with a search query submitted to rank the media file. A corpus of media files indicated in a user device may be ranked based on metadata associated with the media files. Metadata may be assigned to media files of a corpus based on actions taken responsive a search. For example, if a search phrase selects a file and the search phrase includes a keyword not associated with a file the keyword may be associated with a file if a user selects the file responsive to a search. A search query may be directed to a library of media files based on a source of a request. For example, if a user has been granted access rights to a particular library of media such as music, images, videos, etc. a search of media files may be directed to that library and/or media from a library may be ranked higher based on a user. Media files may be ranked based on a source of a media file. A media file may be presented based on a source of a response and a source of a posting to which a response replies. For example, if a person associated with a post and/or a response has been blocked from presentation, content associated with a person may be prevented from being presented.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 is a flowchart of obtaining media associated with a posting.

FIG. 3 is a flowchart of obtaining media associated with a response to a posting.

FIG. 4 depicts an exemplary embodiment of a Graphical User interface (GUI) for submitting a posting.

FIG. 5 depicts an exemplary embodiment of a GUI for obtaining media.

FIG. 6 depicts an exemplary embodiment of a GUI for confirming a posting comprising media.

FIG. 7 depicts an exemplary embodiment of a GUI for selection of a posting.

FIG. 8 depicts an exemplary embodiment of a GUI for submitting a response to a posting.

FIG. 9 depicts an exemplary embodiment of a GUI for obtaining media associated with a posting and a response.

FIG. 10 depicts an exemplary embodiment of a GUI for confirming a response comprising media.

FIG. 11 is a block diagram of an exemplary system embodiment.

FIG. 12 is a flowchart of registering and obtaining information of user activities.

FIG. 13 is a flowchart of delivering an indication or message to a user.

FIG. 14 depicts an exemplary GUI (Graphical User Interface) for providing registration information and inviting peers.

FIG. 15 depicts an exemplary GUI for notification of a peer.

FIG. 16 depicts an exemplary GUI for delivery of a message to a user.

FIG. 17 is an exemplary GUI for presentation of request related information.

FIG. 18 is an exemplary GUI for reviewing of request related information.

FIG. 19 is an exemplary GUI for submitting a response to a request.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes one or more user devices and may comprise a distribution server and a media search device. A user device may be any type of computing device which may comprise a display device. A distribution server may receive requests from user devices and may distribute postings or request of users to other users or responders who may provide an answer or response to a request. A media search device may be incorporated in a user device, may be included in a distribution server and/or may be a separate device which may be connected to other devices via a network.

As used herein, a “request” or query or question means a request for information, products, and/or services. A request or query or posting may include various types of media, and may be provided by any system or device which may establish communication with a server and/or other devices accessible via a network such as the internet, a private network and/or a combination thereof.

A “user” is a person who submits a request and may receive any type of information responsive to a request. A user may be any person or entity. A user who formulates a posting may be referred to as an originator or composer of a posting. A “responder” or answerer may be any person or entity who elects to receive a request and provide a response.

A responder may receive requests in various ways. A responder may elect to receive requests based on one or more categories, keywords or topics assigned to a responder. Profile information associated with a responder may be used to determine when a request is directed to a responder. A ranking of a responder may affect whether a request is directed to a responder. An editor may select a responder to whom a request is directed. A responder may select a posting or question based on a search or filtering functionality provided to a responder.

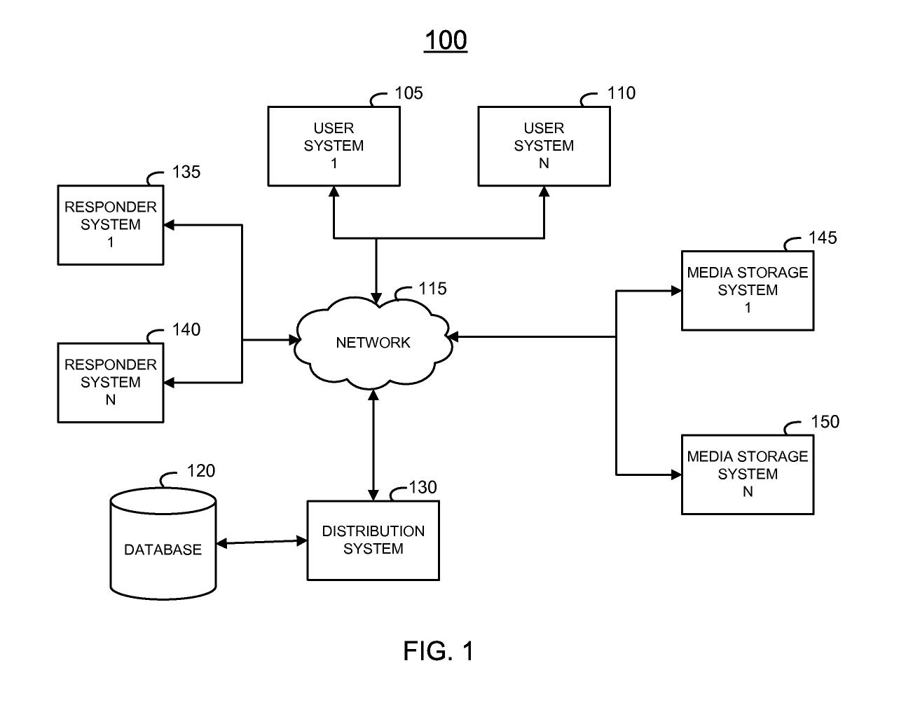

As illustrated in FIG. 1, system 100 includes user systems 105, 110, a network 115 such as the Internet, a distribution system 130, a database 120, which may comprise various records, responder systems 135, 140, and media storage systems 145, 150. A user system, a media storage system and/or a responder system may be operated by a user.

While only a few systems associated with a user, a responder, and a media storage system and a distribution system are depicted in FIG. 1 it is within the scope of the disclosure for multiple systems for a user, a responder, a media system and a distribution service to be utilized. In particular it is envisioned that many user, responder, media storage systems and distribution systems may be implemented. The distribution system 130 and/or the media storage systems 145, 150 may be a composed of many components as described further herein.

The network 115 may be a global public network of networks (i.e., the Internet) and/or may consist in whole or in part of one or more private networks and communicatively couples the user systems 105, 110, the responder systems 135, 140, and the media storage systems 145, 150 with the other components of the system 100 such as the distribution system 130, and the database 120. The network 115 may include one or more wireless networks which may enable wireless communication between the various elements of the system 100. For example, the distribution system 130 may receive messages which may be routed via a wireless network controlled by a wireless service to the user systems 105, 110. A wireless service may receive messages from the responder systems 135, 140 via a wireless network which is a part of the network 115, and provide the messages to the distribution system 130 via an internet connection which is part of the network 115.

The distribution system 130 allows interaction to occur among the user systems 105, 110, the responder systems 135, 140 and the media storage systems 145, 150. For example, a request can be transmitted from the user system 105 to the distribution system 130, which may provide information obtained from the database 120, which may include a response of the responder system 140 which may comprise media obtained from the media storage system 150. Any type of communication between users, and responders may be mediated and/or facilitated by the distribution system 130, and/or other elements of the system 100.

The distribution system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the distribution system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the responder systems 135, 140, the media storage systems 145, 150 and the distribution system 130 may include equipment, software, systems and personnel required to send and/or receive messages between user systems 105, 110, the responder systems 135, 140, the media storage systems 145, 150 and/or the distribution system 130 using the network 115. The database 120 includes information which may allow the distribution system 130 to establish communication between any or all of the elements of the system 100.

A user system, a responder system, a media storage system and/or a distribution system may be a desktop, portable, or tablet computer using an operating system such as Windows®, iOS®, Android®, etc., a mobile phone, a smart phone, a PDA, a server system, a landline phone, a specialized communication terminal, a terminal connected to a mainframe, or any other suitable communication hardware and/or system. The distribution system 130, a user system, a media storage system and/or a responder system may include one or more servers, computers, etc. For example, servers such as the PowerEdge® 2900 by Dell, or the BladeCenterJS22 by IBM, or equivalent systems might be used to implement elements of the distribution system 130 and/or the media storage systems 145, 150. The distribution system 130 and/or any elements of the system 100 may utilize an operating system (OS) such as Microsoft Windows XP, Linux, iOS®, Android®, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, responder systems, media storage systems and/or to implement the distribution system 130.

A user may be identified by the distribution system 130. When a user system accesses the distribution system 130 a user may be identified based on security information provided to the distribution system 130. A user may be provided with a facility for receiving and responding to postings. A user may provide information of other users.

A user may be required to register with the distribution system 130. As part of a registration process, at least one communication service is associated with a user. In at least one embodiment, a user may register with the distribution system 130 and establish a username and password which are associated with the user. A user may login to the distribution system 130 using a web browser functionality of the user system 110 in order to communicate with the distribution system 130. One or more identifiers may be assigned to a user and may be used to identify content such as requests, responses, opinions, etc., associated with a user. A user may provide profile information such as personal information, geographic, background, affiliation, demographic, interest, category, etc. information. A user may provide information required to provide payment. A user may register using a Single Sign On (SSO) facility such as credentials from a distribution system such as the Facebook® or LinkedIn® services. Profile information such as communication information, personal data, etc. may be obtained based on a user sign-in credential, and/or content of a user system.

A responder may be required to register with the distribution system 130. As part of a registration process, at least one communication method is associated with a responder. In at least one embodiment, a responder may register with the distribution system 130 and establish a username and password which are associated with the responder. A responder may login to the distribution system 130 using a web browser functionality of the responder system 145 in order to communicate with the distribution system 130. One or more identifiers may be assigned to a responder and may be used to identify content associated with a responder. A responder may provide profile information such as personal information, geographic, background, affiliation, demographic, interest, category, etc. information. A request may be directed to a responder based on any information associated with a responder. A responder may elect to block requests based on factors such as content, originator, etc. A responder may provide information required to provide payment to a responder.

When a responder is registered with the distribution system 130 the responder may have access to content available from the distribution system 130. This may include sponsored content provided by advertisers, requests, response, data indicated in the database 120, requests of users, topics, etc. A responder may have access privileges based on factors such as experience of the responder, ratings of responses of a responder, revenue obtained based on works of a responder, etc. A responder may be an entity.

Records may be maintained in the database 120 which may be used to record the status of various items. Such records may be used to aid in the selection of media. For example, any information associated with a user such as query history, profile, a social graph of a user, etc. may be used to select media. Likewise, media may be selected based on actions of user which have been recorded, as well as responses of users who receive media.

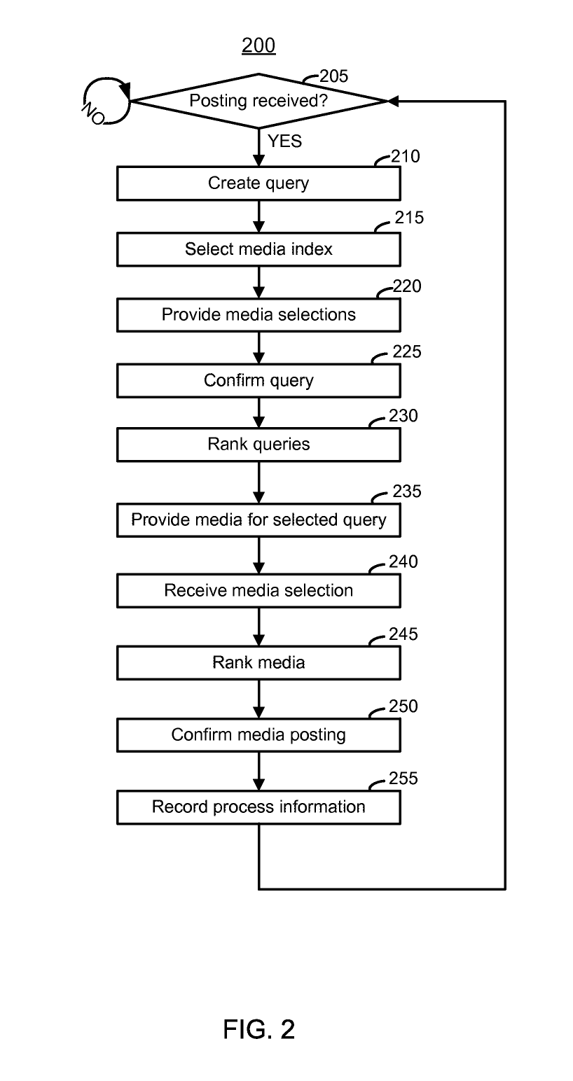

As illustrated in FIG. 2, a process 200 for obtaining media associated with a posting is provided. The process 200 may be performed in whole or in part by any suitable element of the system 100 (FIG. 1). In at least one embodiment, the process 200 is operative on a server associated with the distribution system 130 and/or the user device 110.

In operation 205 (FIG. 2) a determination is made as to whether a post or request or item to be published is received. If it is determined in operation 205 that a post is not received, control remains at operation 205 and process 200 continues. If it is determined in operation 205 that a post is received, control is passed to operation 210 and process 200 continues.

The determination in operation 205 may be made using various criteria. In at least one embodiment, if a message is received at a system associated with the distribution system 130 (FIG. 1), it may be determined that a post is received. For example, if a GET request indicating an identifier of a user is received at a server associated with the distribution system 130, it may be determined that a post is received. Any type of message may be received which may indicate that a post is received. For example, reception of an SMS message, a mobile web message, a message from an App, etc., may be used to determine whether a post is received. A post may be internal to a user device. If a user activates a control of a user device, it may be determined that a post is received.

In operation 210 a query is created. A query may be created in various ways. A query may be copy of a posting which has been submitted by a user. A query may be generated based on content of a posting. A query may be created or generated based on a search result associated with a posting. A query may be generated based on a user associated with a posting based on information such as demographic, geographic, social, personality, etc. information of a user. A query may be generated based on a type of media indicated in a posting. A query may be generated based on content of a user device. Any information of a user associated with a posting and/or other users may be used in any combination to create a query. A number of queries may be created and/or presented responsive to a posting. Control is passed to operation 215 and process 200 continues.

In operation 215, a media index is selected. A media index may be a search engine which includes an index of media files such as images, audio, video, etc. Any number of media indices may be selected. A media index may be preferentially selected based on a query and/or a user. A media index may index public and/or private media collections. A media index may be selected based on access rights associated with a user. Control is passed to operation 220 and process 200 continues.

In operation 220 media selections are provided. A preview and/or visual index of media files retrieved based on any number of selected media indices may be used to obtain media selections which may be provided. Media selections may be indicated using thumbnails and/or snippets depending on a type of media. Media may be provided to a user via any device associated with the user. Control is passed to operation 225 and process 200 continues.

In operation 225 a query is confirmed. For example, a user may be requested to select a specific query from a number of queries which may be offered to a user. A user may observe results of various queries prior to confirming a query. An action and/or inaction by a user may be used to confirm a query. For example, if a user does not respond to an offered query a default query may be used. A user may elect to skip query confirmation. Control is passed to operation 230 and process 200 continues.

In operation 230 queries are ranked. A ranking of a query may affect future creation of queries. If a user selects a query which includes a particular keyword or phrase or a named entity a query comprising the keyword or named entity may be more likely to be offered in a future interaction. Similarly if a confirmed query is generated based on a list of named entities and/or keywords, a ranking of that list or “gazette” may be increased when a future query is constructed. Control is passed to operation 235 and process 200 continues.

In operation 235 media for a selected query is provided. A selection control and/or indicators of available media files which are highly ranked for a selected query may be indicated to a user. Any number of indicators may be displayed and/or identified. Control is passed to operation 240 and process 200 continues.

In operation 240 a media file selection is received. A user may activate a control which may indicate a file such as an image, video, audio, etc. Responsive to a media file selection, a copy of a selected media file may be stored on a server and/or on a user device. Inaction by a user may cause a media file to be selected and/or rejected. Control is passed to operation 245 and process 200 continues.

In operation 245 media is ranked. A ranking of a media file may be adjusted based on a selection. For example, a ranking of a file for a confirmed query and/or a related query may be increased if a media file is selected. Information of a ranking of a media file may be shared with a media indexing system. Control is passed to operation 250 and process 200 continues.

In operation 250 a media posting is confirmed. In some instances a user may obtain a file, but may subsequently discard a media file as unsuitable for a posting. Final content of a posting as submitted may be used to review metadata associated with a media file and may be used to confirm and/or adjust a ranking of a media file. Control is passed to operation 255 and process 200 continues.

In operation 255, process information is recorded. Information of a posting, a user, a media file, a media index, a search query, time, rankings and/or ratings may be recorded. In at least one embodiment, process information is recorded in the database 120 (FIG. 1). Control is passed to operation 205 and process 200 continues.

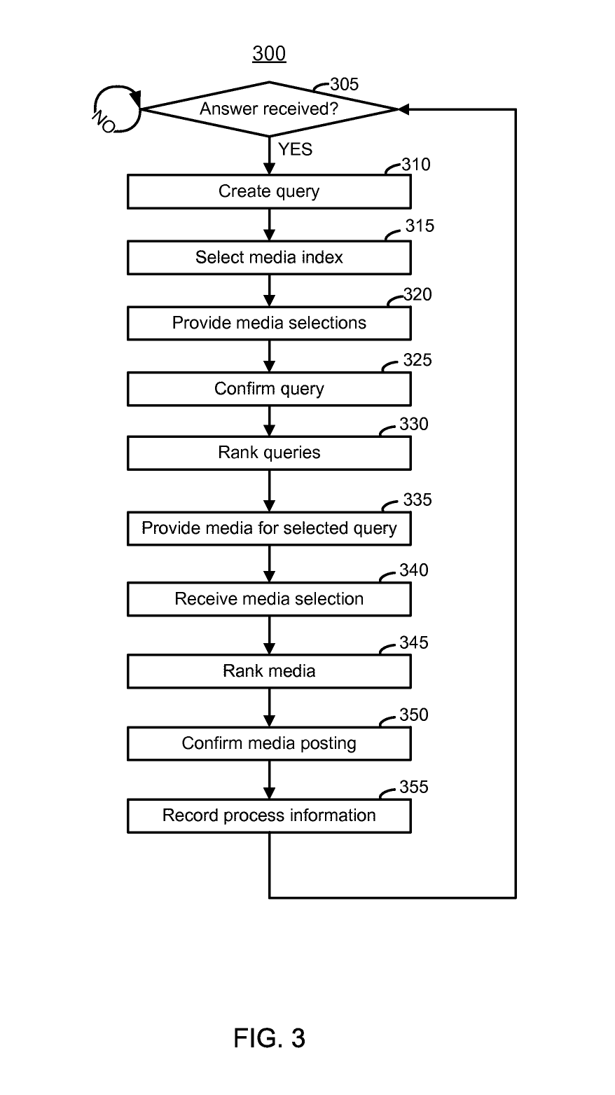

As illustrated in FIG. 3, a process 300 for obtaining media associated with a response and a posting is provided. The process 300 may be performed in whole or in part by any suitable element of the system 100 (FIG. 1). In at least one embodiment, the process 300 is operative on a server associated with the distributor system 130 and/or the user device 110.

In operation 305 (FIG. 3) a determination is made as to whether an answer or response to a posting is received. If it is determined in operation 305 that an answer is not received, control remains at operation 305 and process 300 continues. If it is determined in operation 305 that an answer is received, control is passed to operation 310 and process 300 continues.

The determination in operation 305 may be made using various criteria. In at least one embodiment, if a message is received at a system associated with the distribution system 130 (FIG. 1), it may be determined that an answer is received. For example, if a GET request indicating an identifier of a user is received at a server associated with the distribution system 130, it may be determined that an answer is received. Any number and/or type of message may be received which may indicate that an answer is received. For example, reception of an SMS message, a mobile web message, a message from an App, etc., may be used to determine whether an answer is received. An answer may be internal to a user device. If a user activates a control of a user device, it may be determined that an answer is received.

In operation 310 a query is created. A query may be created in various ways. A query may be created based on content of a response. A query may be created based on a posting and/or answers associated with a response. A query may be created based on whether an answer is a direct reply to a posting and/or a response to an answer to a posting. A query may be created based on media associated with a posting to which an answer is provided. A query may cause content which is already associated with a posting to be excluded and/or ranked lower. A query may be created based on a search result obtained responsive to an answer and/or a posting. Any number of queries may be created. Content of a device of a responder and/or a user associated with a posting may be used to create a query. A glossary or list of terms associated with a media repository may be used to generate a query. If a named entity of a query which located media for a posting is found in an index, a query including named entities of an index may be more likely to be suggested. Any available information may be used to create a query. Control is passed to operation 315 and process 300 continues.

In operation 315, a media index is selected. A media index may be a search engine which includes an index of media files such as images, audio, video, etc. Any number of media indices may be selected. A media index may be preferentially selected based on a query, a response, and/or a user. A media index may index public and/or private media collections. A media index may be selected based on access rights associated with a user and/or a responder. Control is passed to operation 320 and process 300 continues.

In operation 320 media selections are provided. A preview or visual index of media files chosen based on any number of media indices may be used to obtain media selections which may be provided. Media selections may be indicated using thumbnails and/or snippets associated with a type of media. Control is passed to operation 325 and process 300 continues.

In operation 325 a query is confirmed. For example, a user may be requested to select a specific query from a number of queries which may be offered to a user. A user may observe results of various queries prior to confirming a query. A human assistant may confirm a query. An action of a user may be used to confirm a query. For example, if a user does not respond to an offered query a default query may be used. A user may elect to skip query confirmation. Control is passed to operation 330 and process 300 continues.

In operation 330 queries are ranked. A ranking of a query may affect future creation of queries. If a user selects a query which includes a particular keyword or phrase or a named entity a query comprising the keyword or named entity may be more likely to be offered in a future interaction. Similarly if a confirmed query is generated based on a list of named entities and/or keywords, a ranking of that list or “gazette” may be increased when a future query is constructed. A structure of a query may be adjusted based on an action of a user. For example, order of words, keywords, and/or syntax of a query may be used to adjust a rank of a query. Control is passed to operation 335 and process 300 continues.

In operation 335 media for a selected query is provided. A selection control and/or indicators of available media files which are highly ranked for a selected query may be indicated to a user. Any number of indicators may be displayed and/or identified. Media may be presented in any order. An order of presentation of media may depend on a ranking of the media based on any suitable factors. Control is passed to operation 340 and process 300 continues.

In operation 340 a media file selection is received. A user may activate a control which may indicate a file such as an image, and/or video, audio, etc. Responsive to a media file selection, a copy of a selected media file may be stored on a server and/or on a user device. Control is passed to operation 345 and process 300 continues.

In operation 345 media is ranked. A ranking of a media file may be adjusted based on a selection. For example, a ranking of a file for a confirmed query and/or a related query may be increased if a media file has been selected. Information of a ranking of a media file may be shared with a media indexing system and/or media storage system. Control is passed to operation 350 and process 300 continues.

In operation 350 a media posting is confirmed. In some instances a user may obtain a file, but may subsequently discard a media file as unsuitable for a posting. Final content of a posting as submitted may be used to review metadata associated with a media file and may be used to confirm and/or adjust a ranking of a media file. Control is passed to operation 355 and process 300 continues.

In operation 355, process information is recorded. Information of a posting, a user, a media file, a media index, a search query, a search engine, a responder, a posting, an answer, a media file, metadata, time, rankings and/or ratings may be recorded. In at least one embodiment, process information is recorded in the database 120 (FIG. 1). Control is passed to operation 305 and process 300 continues

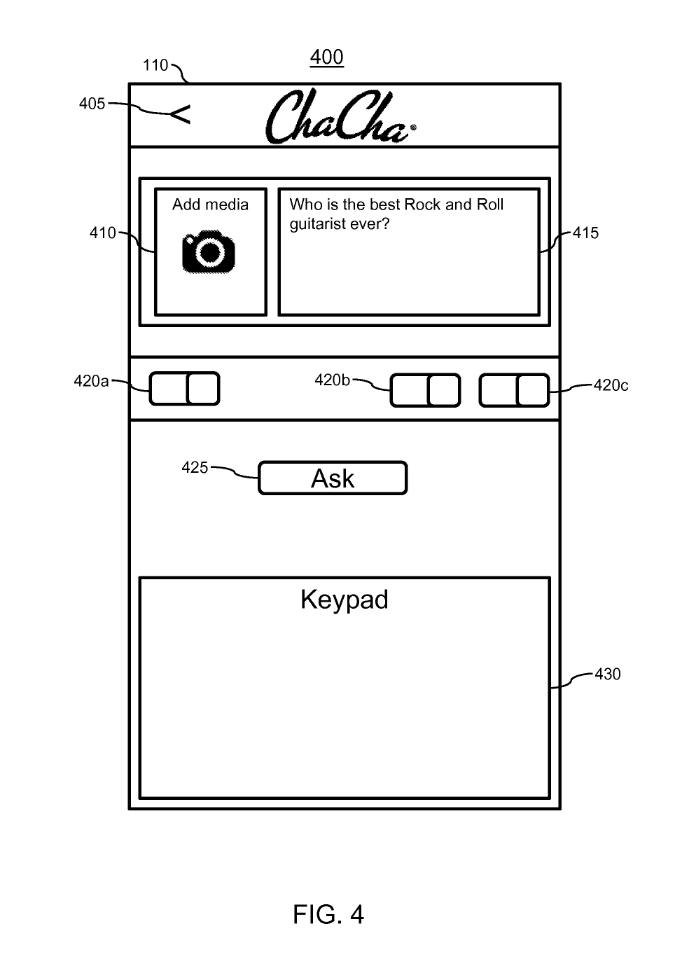

An exemplary GUI 400 for submitting a question or posting is illustrated with respect to FIG. 4. The query submission GUI 400 may comprise a navigation control 405, a media input control 410, a query indicator 415, query distribution controls 420a-420c, a query submission control 425, and user controls 430. The GUI 400 may be presented using a device such as the user device 110 (FIG. 1).

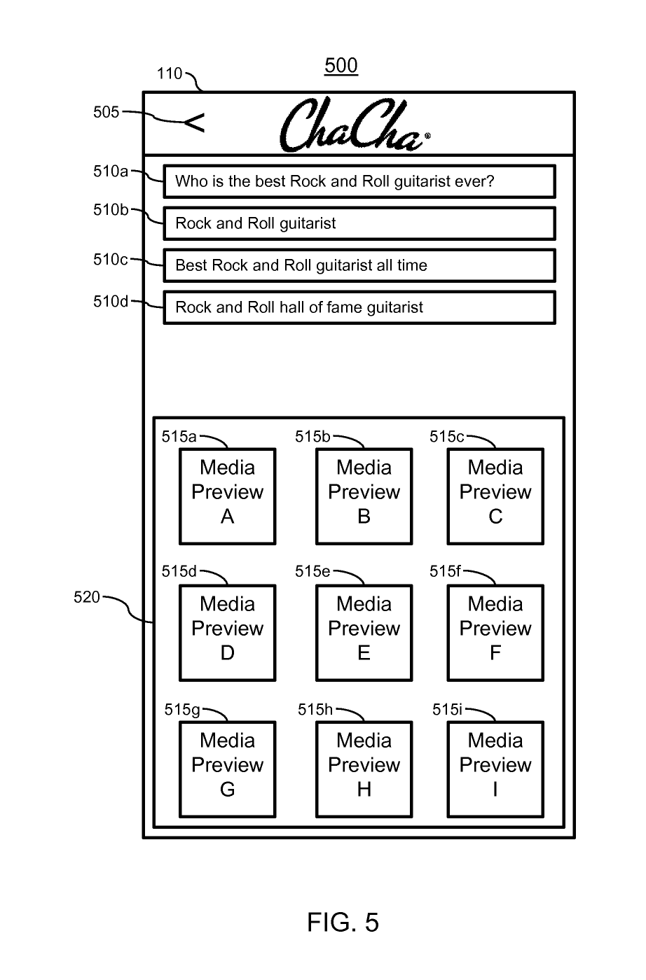

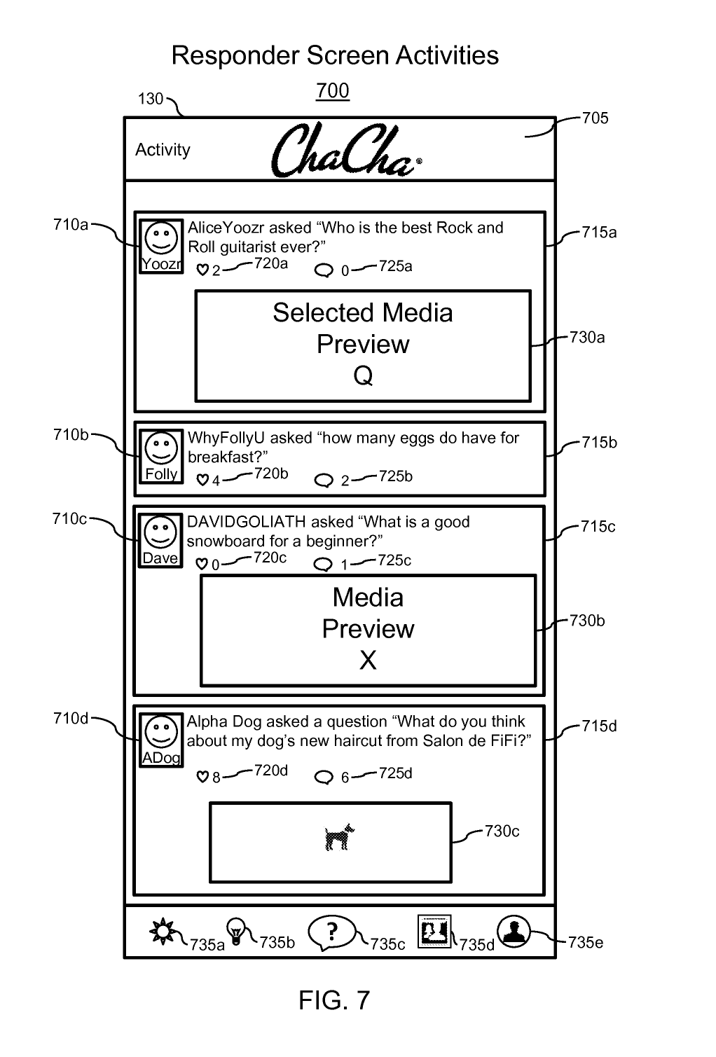

The navigation control 405 may be used to navigate to another UI such as that illustrated in FIG. 7. The media input control 410 may be used to indicate that a media file is to be included in a posting. Activation of the media input control 410 may cause a GUI such as that illustrated in FIG. 5 to be provided. The query indicator 415 may be used to indicate content of a posting. Any sort of media may be indicated in the query indicator 415. The query distribution controls 420a-420c may determine how a posting is distributed. The query distribution control 420a may allow a posting to be made anonymously. The query distribution control 420b may cause a posting to be distributed via a selected social network. The query distribution control 420c may cause a posting to be distributed via an email mailing list. Any number of query distribution controls may be provided. The query submission control 425 may be used to indicate that a posting is to be submitted. The user controls 430 may be used to provide information of a posting. For example, a keypad, voice input, recording, touch, gesture, etc. which may be used to indicate information of a posting may be provided by the user controls 430.

An exemplary GUI 500 for obtaining a selection of media is illustrated with respect to FIG. 5. The media selection GUI 500 may comprise a navigation control 505, query indicators 510a-510d, media indicators 515a-515i, and a media selection area 520. The GUI 500 may be presented using a device such as the user device 110 (FIG. 1).

The navigation control 505 may be used to navigate to another UI such as that illustrated in FIG. 4. The query indicators 510 may be used to indicate a query. For example, the query indicators 510a-510d may indicate queries created based on a posting which is present when the media input control 410 (FIG. 4) is activated. The query indicators 510a-510d may be presented in an order based on a ranking of queries. Activation of a query indicator may cause content of the media selection area 520 to be modified based on a query indicated by a query indicator. The media indicators 515a-515i may be presented in any order. In an embodiment, a media indicator may be presented in an order based on a rank of a file associated with the media indicator for a query determined by a query indicator. Activation of a media indicator may cause content associated with a media indicator to be associated with a posting. The media selection area 520 may provide for scrolling through any number of media indicators. Media indicators may indicate any type of media such as video, images, web content, and/or audio materials and/or pointers to media.

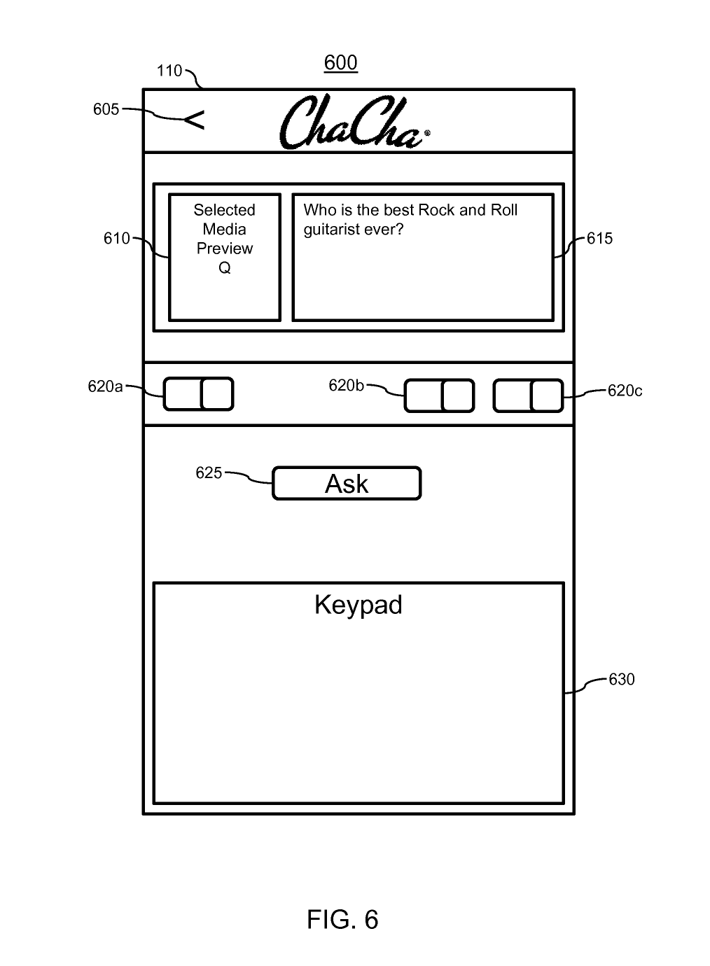

An exemplary GUI 600 for submitting a question or posting with a confirmed media file is illustrated with respect to FIG. 6. The media query submission GUI 600 may comprise a navigation control 605, a media preview control 610, a query indicator 615, query distribution controls 620a-620c, a query submission control 625, and user controls 630. The GUI 600 may be presented using a device such as the user device 110 (FIG. 1).

The navigation control 605 may be used to navigate to another UI such as that illustrated in FIG. 7. The media preview control 610 may be used to indicate that a media file is to be included in a posting. For example, an indicator of a media file selected using a GUI such as the GUI 500 (FIG. 5) may be provided in the media preview control 610. Activation of the media input control 610 may cause a GUI such as the GUI 500 (FIG. 5) to be provided. The query indicator 615 may be used to indicate content of a posting. Any sort of media may be indicated in the query indicator 615. The query distribution controls 620a-620c may determine how a posting is distributed. The query distribution control 620a may allow a posting to be made anonymously. The query distribution control 620b may cause a posting to be distributed via a selected social network. The query distribution control 620c may cause a posting to be distributed via an email mailing list. Any number of query distribution controls may be provided. The query submission control 625 may be used to indicate that a posting is to be submitted. If the query submission control is activated, information of a media file indicated in the media preview control 610 may be stored and/or may be used to rank queries, media files, users, etc. The user controls 630 may be used to provide information of a posting. For example, a keypad, voice input, recording, touch, gesture, etc. which may be used to indicate information of a posting may be provided by the user controls 630.

An exemplary GUI 700 for selecting a question or posting is illustrated with respect to FIG. 7. The query selection GUI 700 may comprise a task type indicator 705, user indicators 710a-710d, query indicators 715a-715d, affirmation indicators 720a-720d, response indicators 725a-725d, media indicators 730a-730c, and navigation controls 735a-735e. The GUI 700 may be presented using a device such as the responder device 130 (FIG. 1).

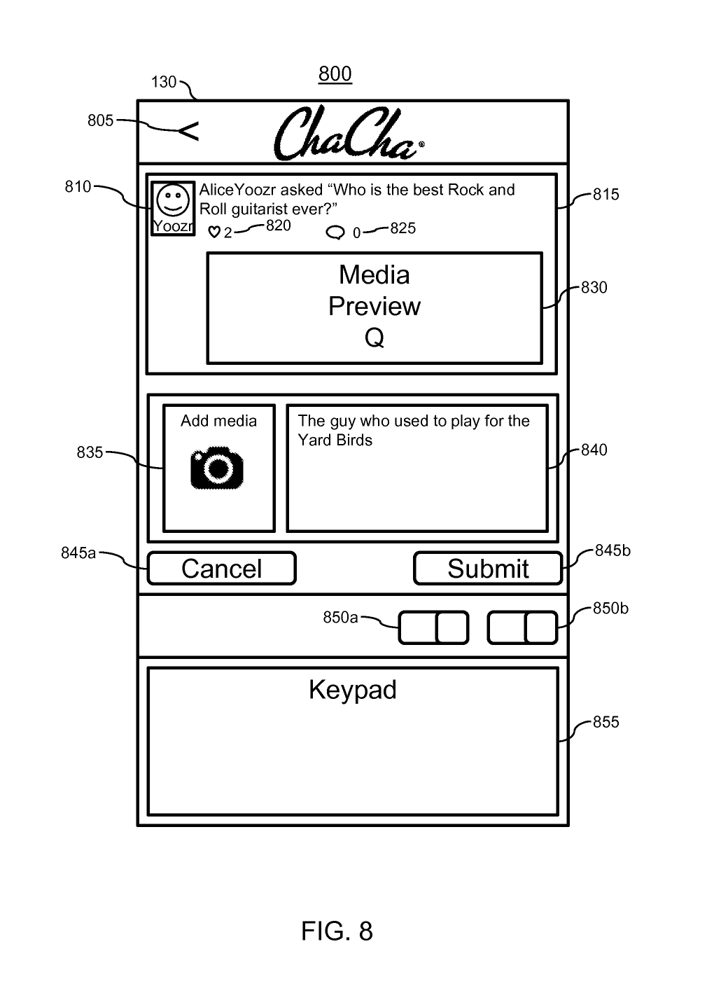

The user controls 710a-710d may indicate information of a user who submits a posting. The query indicators 715a-715d may be used to provide information of a posting. Activation of a query indicator may cause information of a query to be presented using a GUI such as that illustrated in FIG. 8. The query affirmation indicators 720a-720d may be used to indicate a number of times a posting has received positive reinforcement. The response indicators 725a-725d may be used to indicate a number of responses associated with a posting. The media indicators 730a-730c may be used to indicate media associated with a posting. For example the media indicator 730a may indicate a media file selected to be associated with the posting “Who is the best Rock and Roll guitarist ever?” which may have been selected using the GUI 500 (FIG. 5) and confirmed using the GUI 600 (FIG. 6). The navigation controls 735a-735e may be used to navigate to various activities. The navigation control 735a may cause information of postings which are most active to be presented. The navigation control 735b may cause the GUI 700 to be provided. The navigation control 735c may cause the GUI 400 (FIG. 4) to be provided. The navigation control 735d may cause information of activities associated with a user to be provided. The navigation control 735e may cause profile information, historical postings and replies, and user network information to be provided.

An exemplary GUI 800 for submitting a reply or response is illustrated with respect to FIG. 8. The media response submission GUI 800 may comprise a navigation control 805, a user indicator 810, a posting indicator 815, a query affirmation indicator 820, a query response indicator 825, a posting media preview indicator 830, a response media selection control 835, a response indicator 840, response controls 845a, 845b, response distribution indicators 850a 850b, and a user input control 855. The GUI 800 may be presented using a device such as the responder device 130 (FIG. 1).

The navigation control may be used to navigate to a GUI such as the GUI 700 (FIG. 7). The user indicator 810 may indicate information of a user associated with a posting. The posting indicator 815 may be used to indicate information of a query or posting. The query affirmation indicator 820 may indicate a number of times a posting has received affirmation. The query response indicator 825 may indicate a number of times a query has received a response. The posting media preview indicator 830 may indicate information of media associated with a posting. Activation of the posting media indicator 830 may cause information of media to be presented.

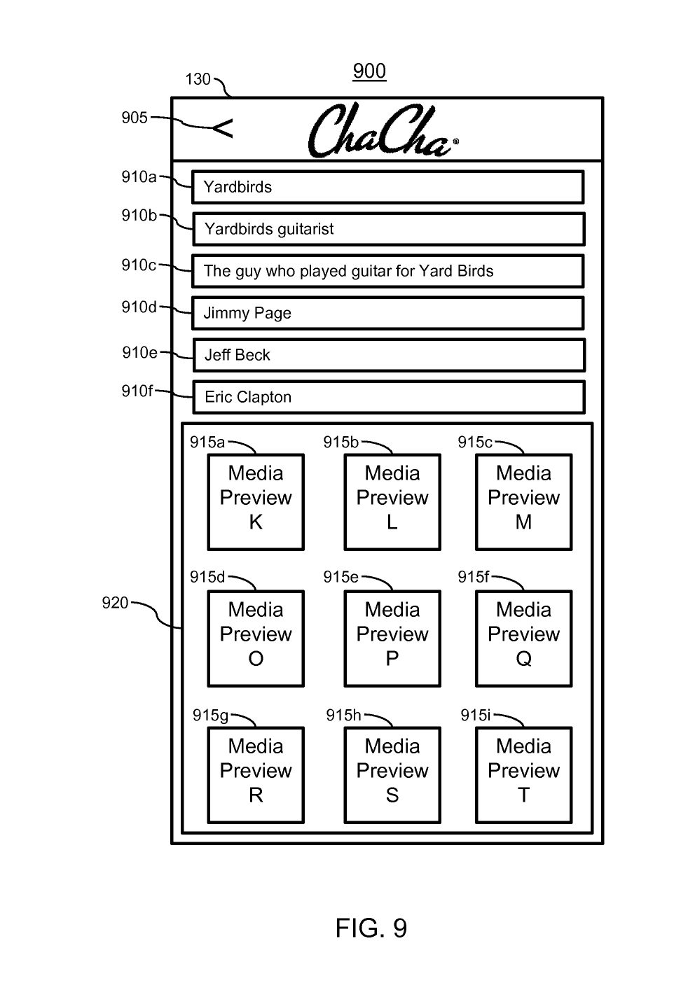

The response media selection indicator 835 may be used to indicate that media is to be associated with a response. Activation of the response media indicator 835 may cause a GUI such as that illustrated in FIG. 9 to be provided. The response indicator 840 may be used to provide information of a response. Any type of media may be indicated in the response indicator 840. The response controls 845a, 845b may be used to determine whether a response is submitted. The response control 845a may be used to cancel submission of a response. The response control 845b may be used to cause a response to be submitted. The response distribution controls 850a, 850b may be used to determine a distribution for a response. For example, a group of users, a distribution list, etc. may be indicated by the distribution controls 850a, 850b. The user controls 855 may be used to provide information of a response. For example, a keypad, voice input, recording, touch, gesture, etc. which may be used to indicate information of a response may be provided by the user controls 855.

An exemplary GUI 900 for obtaining a selection of media associated with a response is illustrated with respect to FIG. 9. The response media selection GUI 900 may comprise a navigation control 905, query indicators 910a-910f, media indicators 915a-915i, and a media selection area 920. The GUI 900 may be presented using a device such as the responder device 130 (FIG. 1).

The navigation control 905 may be used to navigate to another UI such as that illustrated in FIG. 8. The query indicators 910 may be used to indicate a query. For example, the query indicators 910a-910f may indicate queries created based on a posting and/or a response which is present when the response media input control 810 (FIG. 8) is activated. A user may provide a query in a query indicator 910 using any suitable input device. Content of the query indicators 910a-910f may be based on a search result such as a result of a search using a portion of a response. The query indicators 910a-910f may be presented in an order based on a ranking of queries. Activation of a query indicator may cause content of the media selection area 920 to be modified based on a query indicated by a query indicator. The media indicators 915a-915i may be presented in any order. In an embodiment, a media indicator may be presented in an order based on a rank of the media indicator for a query determined by a query indicator. Activation of a media indicator may cause content associated with a media indicator to be associated with a response. The media selection area 920 may provide for scrolling through any number of media indicators. Media indicators may indicate any type of media such as video, images, web content, and/or audio materials and/or pointers to media.

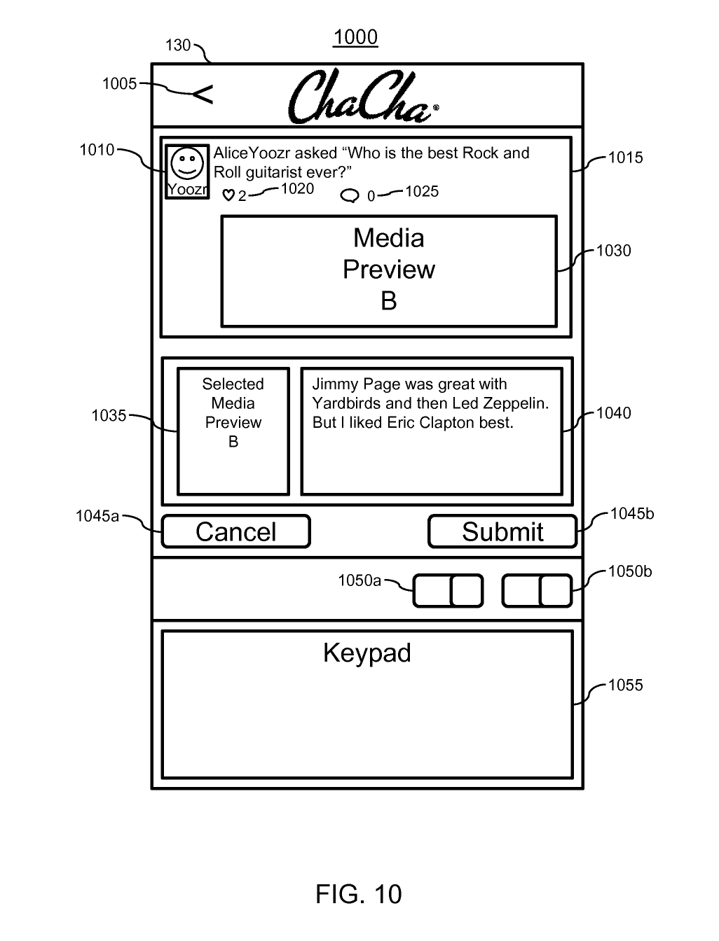

An exemplary GUI 1000 for submitting a reply or response is illustrated with respect to FIG. 10. The media response submission GUI 1000 may comprise a navigation control 1005, a user indicator 1010, a posting indicator 1015, a query affirmation indicator 1020, a query response indicator 1025, a posting media preview indicator 1030, a response media selection control 1035, a response indicator 1040, response controls 1045a, 1045b, response distribution indicators 1050a 1050b, and a user input control 1055. The GUI 1000 may be presented using a device such as the responder device 130 (FIG. 1).

The navigation control 1005 may be used to navigate to a GUI such as the GUI 700 (FIG. 7). The user indicator 1010 may indicate information of a user associated with a posting. The posting indicator 1015 may be used to indicate information of a query or posting. The query affirmation indicator 1020 may indicate a number of times a posting has received affirmation. The query response indicator 1025 may indicate a number of times a query has received a response. The posting media preview indicator 1030 may indicate information of media associated with a posting. Activation of the posting media indicator 1030 may cause information of media to be presented.

The response media selection indicator 1035 may be used to indicate media is to be associated with a response based on an indicator selected using the GUI 900 (FIG. 9). Activation of the response media indicator 1035 may cause a GUI such as that illustrated in FIG. 9 to be provided. The response indicator 1040 may be used to provide information of a response. Any type of media may be indicated in the response indicator 1040. The response controls 1045a, 1045b may be used to determine whether a response is submitted or confirmed. The response control 1045a may be used to cancel submission of a response. The response control 1045b may be used to cause a response to be submitted. The response distribution controls 1050a, 1050b may be used to determine a distribution for a response. For example, a group of users, a distribution list, etc. may be indicated by the distribution controls 1050a, 1050b. The user controls 1055 may be used to provide information of a posting. For example, a keypad, voice input, recording, touch, gesture, etc. which may be used to indicate information of a posting may be provided by the user controls 1055.

Using the method and systems described herein media may be obtained which may be associated with a posting and/or a response to a posting. Media may be selected by a search of an index of media and/or a collection. A search facility is provided which creates a query which may be used to perform a search for a media file. A query may be created based on content of a posting. A query may be created based on attributes of a user submitting a post. A query may be created based on a target recipient of a posting. A ranking of keywords may be used to generate a query. A list of keywords, phrases, named entities and/or other information may be used to generate a query. A ranking of keywords may be created based on frequency of usage, inverse usage frequency and/or other statistical data obtained from a corpus. A search facility may provide information of media files. Indicators of media files may be provided in an order based on a ranking of media files. A selection of a media file and/or a confirmation of a posting of a media file may be used to change a probability that information of a media file will be presented. Responses such as replies and/or affirmation of a posting and/or an answer may affect a ranking of a media file. Information of a posting may affect a ranking of a media file. A media file which is already associated with a posting may be ranked differently than if it has not been associated with a posting.

A search facility may present possible queries created based on content of a response. For example, if a keyword is a highest ranking keyword of a query the keyword may be presented in a list of probable or suggested search queries for selection of a media file. A ranking of a media file for a response may be affected by a source of a post to which the response is targeted. A ranking of a media file may be based on metadata associated with a response. For example, if a number of media files have been associated with responses to a posting, metadata associated with media files of the responses may affect a query and/or a ranking of a media file associated with a response. A category may be assigned to a post based on content of a post and/or responses to a post. A media file may be selected and/or ranked based on a category and/or content of a request.

A ranking of a media file may be modified based on selections of media files to be posted with a response and/or posting. For example, if a media file is presented as a highest ranking media file and a different media file is selected to be provided in conjunction with a post and/or response a ranking of the media file may be reduced for future queries associated with a search query submitted to rank the media file. A corpus of media files indicated in a user device may be ranked based on metadata associated with the media files. Metadata may be assigned to media files of a corpus based on actions taken responsive a search. For example, if a search phrase selects a file and the search phrase includes a keyword not associated with a file the keyword may be associated with a file if a user selects the file responsive to a search. A search query may be directed to a library of media files based on a source of a request. For example, if a user has been granted access rights to a particular library of media such as music, images, videos, etc. a search of media files may be directed to that library and/or media from a library may be ranked higher based on a user. Media files may be ranked based on a source of a media file. A media file may be presented based on a source of a response and a source of a posting to which a response replies. For example, if a person associated with a post and/or a response has been blocked from presentation, content associated with a person may be prevented from being presented. If a response is modified from a response which is used to choose a media file a modification may be used to rank a media file. A search result obtained based on a posting and/or a response may be used to create a query.

In social networking systems, engagement of users is paramount to success. The more times a user visits a social network, the greater the opportunities for interaction and the greater the opportunities to benefit from the network become. Many social networks may send updates to users to remind the users to return to the network. For example, the FaceBook® service may send App notifications or emails when a friend of a user posts some new materials. Likewise, a professional network such as the LinkedIn® service may send email or App notifications when a business acquaintance is linked with a particular event such as a job change or anniversary or promotion.

However, these sorts of notification systems may have some intrinsic weaknesses. If a notification is too frequent, a user may simply ignore the notifications. If a notification comes from someone who is an acquaintance, but not a close friend, the notification may be ignored. Notifications may be less relevant if they originate with people who are not well known to a user. For example, notifications to connect with a stranger or requests to become friends with people who are unfamiliar may be ignored and may cause a user to turn off those types of notifications. For these and other reasons a method and system of peer to peer notification would be greatly appreciated.

A system is implemented whereby users may submit a query and/or may respond to and interact with others regarding any query. A system for interaction may include an opportunity to invite colleagues, or friends from other social networks to participate. If a user has not interacted with the system for a time period a number of peers may be selected. A notification may be delivered to a selected peer. A notification may request a peer to permit his name and/or information to be used to send a notification to a user. If a peer grants permission a notification regarding the system may be delivered to a user which may include information provided by the peer.

When a peer is invited, a user may establish a linkage with that peer. A user may seek out peers by searching for them. For example an identifier associated with a related social network might be used, and/or other personal information could be used. When a user is linked to a peer, that linkage may be recorded and used for targeting of a notification. Interactions with content may be used to select a peer. If a user and a peer have recently interacted a ranking of the peer versus other peers for receiving a notification may increase, which may make a peer more likely to receive a notification. If a user responds to a peer a ranking may be increased by a higher amount than if a peer responds to a user. If a peer and a user respond to the same posting, a different adjustment to ranking may be applied. A number of interactions, a number of exchanges, a type of interaction, a frequency of interaction, a number of peers involved in an interaction, a number of persons not linked to a user, links between peers in an interaction, etc. may be used to determine a probability that a peer will be selected to receive a notification. A peer may select information included in a prompt or indication provided to a user. For example, a peer may be presented with a selection of recent activities which may be included in a prompt. A peer may be selected if a user is following or subscribing to information provided by a peer.

If more than one peer responds to a notification, information of a highest ranking peer may be used to prompt a user. If more than one peer responds to a notification, information of a number of peers may be included in a prompt delivered to a user. Information of recent activities may be included in a prompt to a user. Information of previous activities which involved a user and a number of peers may be included in a prompt to a user. Information of activities in which a peer has participated which are similar to previous activities in which a peer and a user have participated may be included in a prompt. A prompt may include media such as audio, video, images, text, etc.

A system is provided which includes one or more user devices and may comprise a distribution server and messaging servers for transmission of messages using services between a user and another user or peer. A user device may be any type of computing and/or communication device and may comprise a display device. A distribution server may receive requests from user devices and may distribute requests to users and/or other destinations and may track interactions and activities associated with users. A messaging server may perform services such as email, Instant Messaging (IM), Short Messaging Service (SMS), Multi-Media Messaging (MMS), private messaging within a social media system, etc.

As used herein, a “request” or query or question means a request for information, products, and/or services. A request or query may include various types of media, and may be provided by any system or device which may establish communication with a server and/or other devices accessible via a network such as the internet, a private network and/or a combination thereof.

A “user” is a person who submits a request and may receive any type of information responsive to a request. A user may be any person or entity. A “responder” or answerer may be any person or entity who elects to receive a request and provide a response. A “peer” may be any user who may be associated with another user based on associations which are explicit such as identifiers provided by a user and confirmed by a peer, or implicit such as historical activities which indicate a relationship between a user and a peer.

A responder may receive requests in various ways. A responder may elect to receive requests based on one or more categories, keywords or topics assigned to a responder. Profile information associated with a responder may be used to determine when a request is directed to a responder. A ranking of a responder may affect whether a request is directed to a responder. An editor or system administrator may select a responder to whom a request is directed.

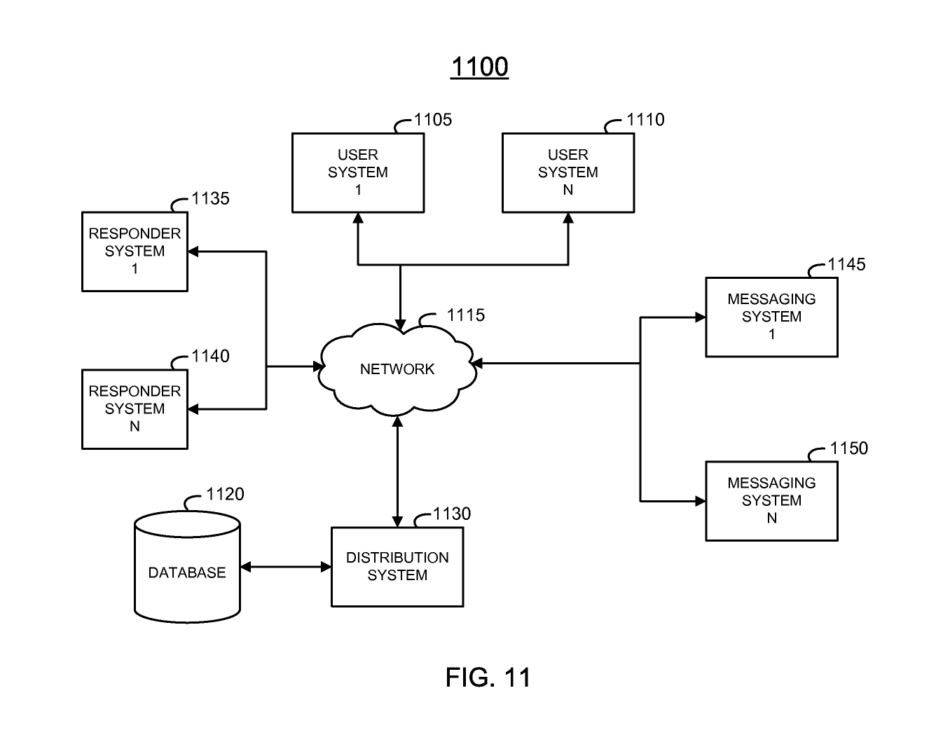

As illustrated in FIG. 11, system 1100 includes user systems 1105, 1110, a network 1115 such as the Internet, a distribution system 1130, a database 1120, which may comprise various records, responder systems 1135, 1140, and messaging systems 1145, 1150. A user system and/or a responder system may be operated by a user or peer.

While only a few systems associated with a user, a responder, a messaging service and a distribution system are depicted in FIG. 11 it is within the scope of the disclosure for multiple systems for a user, a responder, a messaging service and a distribution service to be utilized. In particular it is envisioned that many user, responder, messaging and distribution systems may be implemented. The distribution system 1130 and/or the messaging systems 1145, 1150 may be a composed of many components as described further herein.

The network 1115 may be a global public network of networks (i.e., the Internet) and/or may consist in whole or in part of one or more private networks and communicatively couples the user systems 1105, 1110, the responder systems 1135, 1140, and messaging systems 1145, 1150 with the other components of the system 1100 such as the distribution system 1130, and the database 1120. The network 1115 may include one or more wireless networks which may enable wireless communication between the various elements of the system 1100. For example, the distribution system 1130 may receive messages which may be routed via a wireless network controlled by a wireless service to the user systems 1105, 1110. A wireless service may receive messages from the responder systems 1135, 1140 via a wireless network which is a part of the network 1115, and provide the messages to the distribution system 1130 via an internet connection which is part of the network 1115.

The distribution system 1130 allows interaction to occur among the user systems 1105, 1110, the responder systems 1135, 1140, and the messaging systems 1145, 1150. For example, a request can be transmitted from the user system 1105 to the distribution system 1130, which may provide information obtained from the database 1120, which may include an advertisement to the responder system 1145. Any type of communication between users, and responders may be mediated and/or facilitated by the distribution system 1130, and/or other elements of the system 1100. It is envisioned that communication between user systems and/or responder systems may be accomplished using messaging systems which excludes the distribution system 1130.

The distribution system 1130 is communicatively coupled with the database 1120. As will be described herein in further detail below, the database 1120 includes data that is processed in association with operation of the embodiments. Although FIG. 11 illustrates the database 1120 as a separate component of the system, the database 1120 may be integrated with the distribution system 1130. Further, the records maintained in the database 1120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 1120 may reside in any suitable elements of the system 1100. Any or all elements of the system 1100 may include any or the entirety of the database 1120.

The user systems 1105, 1110, the responder systems 1135, 1140, the messaging systems 1145, 1150 and the distribution system 1130 may include equipment, software, systems and personnel required to send and/or receive messages between user systems 1105, 1110, the responder systems 1135, 1140, the messaging systems 1145, 1150 and/or the distribution system 1130 using the network 1115. The database 1120 includes information which may allow the distribution system 1130 to establish communication between any or all of the elements of the system 1100.

A user system, a responder system, a messaging system and/or a distribution system may be a desktop, portable, or tablet computer using an operating system such as Windows®, iOS®, Android®, etc., a mobile phone, a smart phone, a PDA, a server system, a landline phone, a specialized communication terminal, a terminal connected to a mainframe, or any other suitable communication hardware and/or system. The distribution system 1130, a user system, a messaging system and/or a responder system may include one or more servers, computers, etc. For example, servers such as the PowerEdge® 2900 by Dell, or the BladeCenterJS22 by IBM, or equivalent systems might be used to implement elements of the distribution system 1130. The distribution system 1130 may utilize an operating system (OS) such as Microsoft Windows XP, Linux, iOS®, Android®, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, responder systems, messaging system and/or to implement the distribution system 1130.

A user may be identified by the distribution system 1130. When a user system accesses the distribution system 1130 a user may be identified based on security information provided to the distribution system 1130. A user may receive responses based on a number of requests composed by a user. A user may provide information of relationships to peers.

A user may be required to register with the distribution system 1130. As part of a registration process, at least one communication method is associated with a user. In at least one embodiment, a user may register with the distribution system 1130 and establish a username and password which are associated with the user. A user may login to the distribution system 1130 using a web browser functionality of the user system 1110 in order to communicate with the distribution system 1130. One or more identifiers may be assigned to a user and may be used to identify content such as requests, responses, opinions, etc., associated with a user. A user may provide profile information such as personal information, geographic, background, affiliation, demographic, interest, category, etc. information. A user may provide information required to provide payment. A user may register using a Single Sign On (SSO) facility such as credentials from a distribution system such as the Facebook® or LinkedIn® services. Profile information such as communication information, personal data, etc. may be obtained based on a user sign-in credential, and/or content of a user system. A user may provide information required for the distribution system to access association data of peers from a number of social networking services such as Google+, FaceBook, Twitter, etc.

A responder may be required to register with the distribution system 1130. As part of a registration process, at least one communication method is associated with a responder. In at least one embodiment, a responder may register with the distribution system 1130 and establish a username and password which are associated with the responder. A responder may login to the distribution system 1130 using a web browser functionality of the responder system 1145 in order to communicate with the distribution system 1130. One or more identifiers may be assigned to a responder and may be used to identify content associated with a responder. A responder may provide profile information such as personal information, geographic, background, affiliation, demographic, interest, category, etc. information. A request may be directed to a responder based on any information associated with a responder. A responder may elect to block requests based on factors such as content, originator, etc. A responder may provide information required to provide payment to a responder.

The distribution system 1130 may have access to the messaging systems 1145, 1150. The user systems 1105, 1110 and/or the responder systems 1135, 1140 may communicate using services which exclude the distribution system 1130.

Records may be maintained in the database 1120 which may be used to record the status of various items. Such records may be used to aid the targeting of content provided by advertisers, track activities of users, determine usage history of websites, publisher content, and advertisements, etc. For example, a user may activate an indicator distributed by a publisher, which may cause a request to be received by the distribution system 1130, which may obtain website activity information which may be used to select content to be provided to a user responsive to a request. Similarly, the database may include records of activities of users, responders and interactions including based on topics, subject matter, hashtags, a social network, etc.

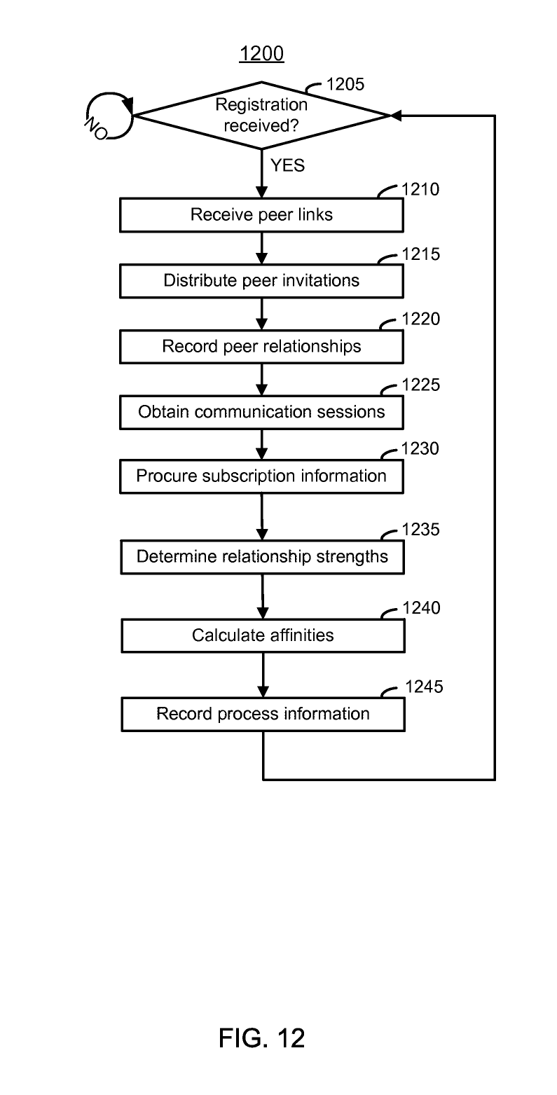

As illustrated in FIG. 12, a process 1200 for obtaining information of interactions, associations, and/or activities is provided. The process 1200 may be performed in whole or in part by any suitable element of the system 1100 (FIG. 11). In at least one embodiment, the process 1200 is operative on a server associated with the distribution system 1130 and/or the user device 1110.

In operation 1205 (FIG. 12) a determination is made as to whether a registration is received. If it is determined in operation 1205 that a registration is not received, control remains at operation 1205 and process 1200 continues. If it is determined in operation 1205 that a registration is received, control is passed to operation 1210 and process 1200 continues.

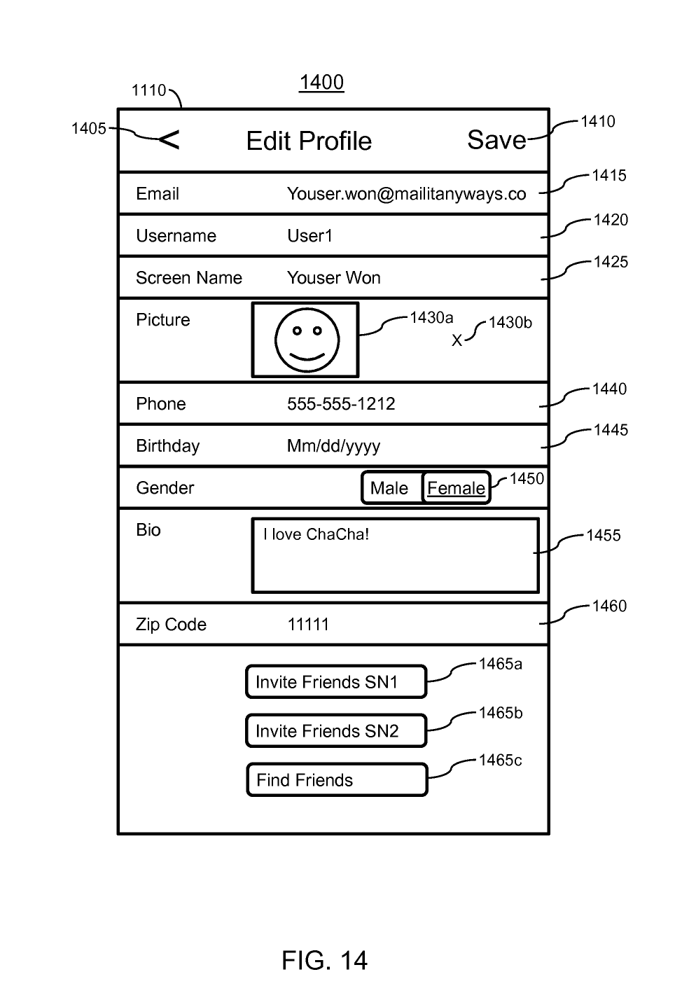

The determination in operation 1205 may be made using various criteria. In at least one embodiment, if a message is received at a system associated with the distribution system 1130 (FIG. 11), it may be determined that a registration is received. For example, if a GET request indicating an identifier of a user is received at a server associated with the distribution system 1130, it may be determined that a registration is received. Any type of message may be received which may indicate that a registration is received. For example, reception of an SMS message, a mobile web message, a message from an App, etc., may be used to determine whether a registration is received. A registration may be performed using an interface such as that illustrated in FIG. 14.

In operation 1210 peer links are received. Peer links may be received in various ways. For example, a user may provide explicit contact information of peers such as email addresses, phone numbers, etc. Content of a user device may be obtained which may include information required to contact peers. A user may provide access information which may permit access to contact information of peers, which may include files accessible on a server such as a cloud server. Control is passed to operation 1215 and process 1200 continues.

In operation 1215, peer invitations are distributed. An invitation may be distributed in any suitable medium. In at least one embodiment, a communication service through which an invitation is distributed may identify the service. If an invitation is accepted based on a communication service, the communication service may be identified as a preferred communication service for a peer. If a peer accepts an invitation, a message may be delivered to a user to indicate acceptance. An invitation may be delivered to a peer who is not registered with the distribution server 1130, which may require a peer to register with the distribution server. An invitation may be delivered to a peer who is registered with the distribution server, which may be acknowledged by a peer. Control is passed to operation 1220 and process 1200 continues.

In operation 1220 peer relationships are recorded. Peer relationships may be based on data of various social networks. For example if a peer is connected with a user based on a plurality of social networks a strength associated with a relationship may be increased. Peer relationships may be affected by a type of connection such as ‘family’ per FaceBook, subscriber or ‘Follower’ per Twitter, etc. Control is passed to operation 1225 and process 1200 continues.

In operation 1225 communication sessions are obtained. Communication sessions may include information such as an initial posting or request, identifiers of users, content of responses or answers to a request, content of replies, positive and/or negative feedback regarding requests, answers, replies, and feedback, and/or temporal and or user information associated with a communication activity. Control is passed to operation 1230 and process 1200 continues.

In operation 1230 subscription information is procured. Subscription information may be obtained from social networks. Information of persons and/or entities which subscribe or follow postings of a user and/or who follow a user may be obtained from accounts to which a user has provided access. Subscriptions maintained by the distribution server 1130 (FIG. 11) may be obtained. Subscriptions of peers may be obtained. Control is passed to operation 1235 and process 1200 continues.

In operation 1235 relationship strengths are determined. Relationship strengths may be determined based on peer links, accepted invitations, social networks, user interactions, and/or user subscriptions. Content of communications may be analyzed to determine a topic and/or subject matter associated with interactions, which may affect relationship strength. A common subscription may increase relationship strength. A number of subscribers associated with a subscription may reduce relationship strength. Direct interactions between a user and a peer may increase relationship strength. Blocking of a user and/or complaints regarding a posting may reduce relationship strength. Control is passed to operation 1240 and process 1200 continues.

In operation 1240 affinities are calculated. Affinities may be adjusted at any time based on changes to factors affecting relationship strength. Affinities may be used for various purposes. Any type of content may be delivered to a user based on affinities. Affinities may be used to determine whether users who are not linked might be linked. For example, suggested subscriptions may be offered to a user based on affinities, requests may be preferentially provided to a user based on affinities, etc. Control is passed to operation 1245 and process 1200 continues.

In operation 1245, process information is recorded. Information of a request, an answer, a reply, feedback, a user, a responder, an affinity, a relationship, a publisher, a website, an advertiser, content, targeting parameters, user actions, compensation of a publisher, responder, editor, advertiser, etc., a rating, a ranking, etc. may be recorded. In at least one embodiment, process information is recorded in the database 1120 (FIG. 11). Control is passed to operation 1205 and process 1200 continues.

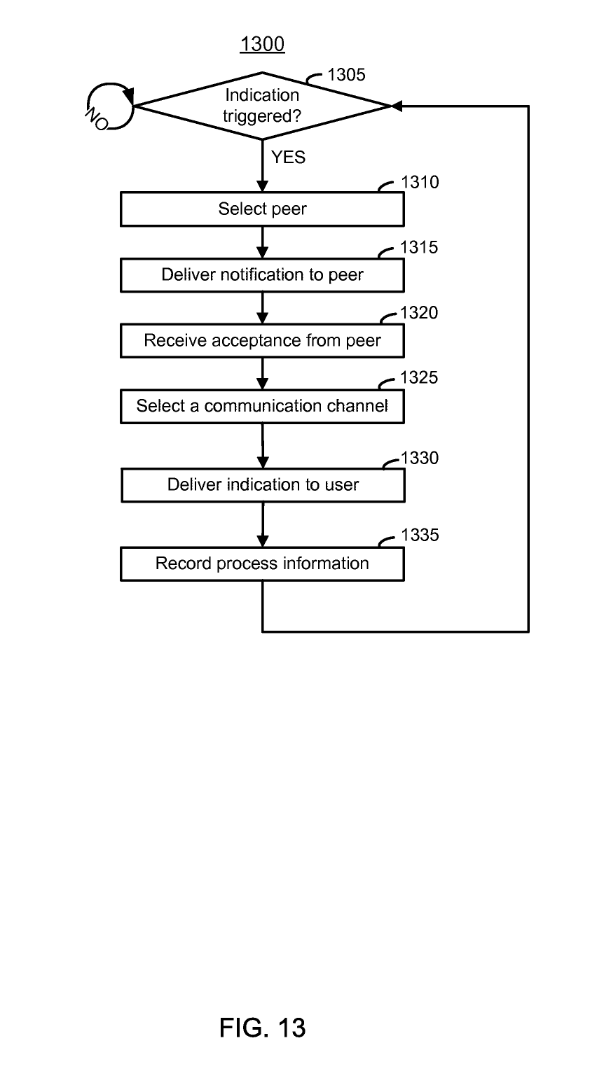

As illustrated in FIG. 13, a process 1300 for providing an indication is provided. The process 1300 may be performed in whole or in part by any suitable element of the system 1100 (FIG. 11). In at least one embodiment, the process 1300 is operative on the distributor system 1130.

In operation 1305 (FIG. 13) a determination is made as to whether an indication is triggered. If it is determined in operation 1305 that an indication is not triggered, control remains at operation 1305 and process 1300 continues. If it is determined in operation 1305 that an indication is triggered, control is passed to operation 1310 and process 1300 continues.

The determination in operation 1305 may be made using various criteria. An indication may be triggered based on a time interval between a current time and a last interaction with a user. An interaction frequency of a user may affect whether an indication is triggered. For example, if a user has visited daily, and then does not return for a week, an indication might be triggered sooner than an indication for a user that visited once per week. Factors such as a number of associations, strength of associations, responsiveness of peers, whether a user has accepted a previous indication, etc., may affect whether an indication is triggered.

In operation 1310 a peer is selected. Any number of peers may be selected. Peers may be selected based on factors such as affinities, time of day, current availability status, types of communications services, etc. Any suitable criteria may be used to select a peer. Control is passed to operation 1315 and process 1300 continues.

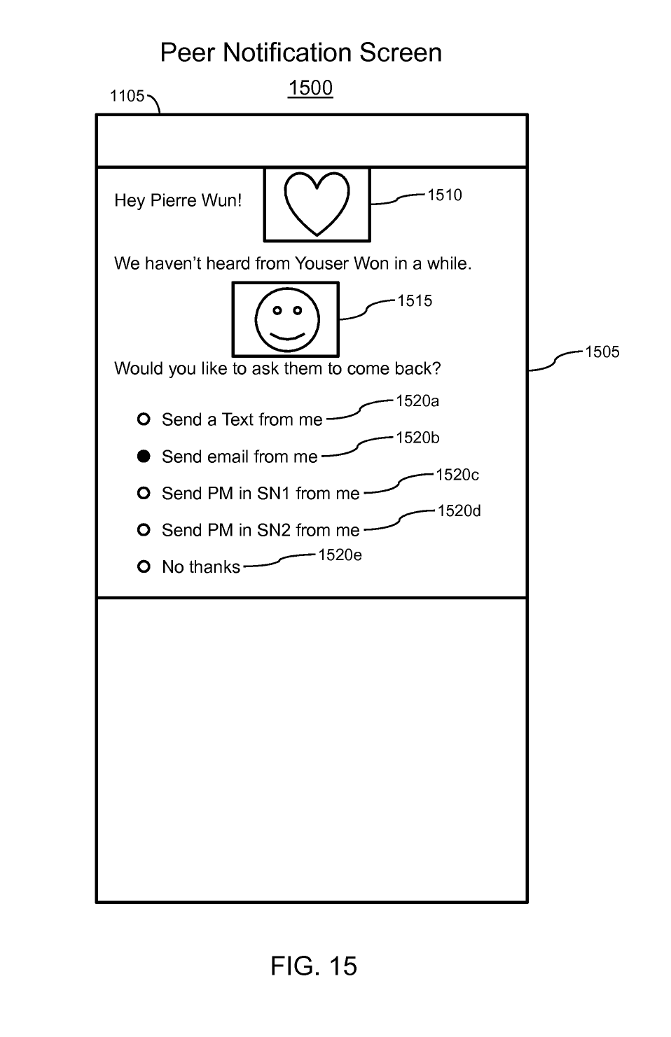

In operation 1315 a notification is delivered to a peer. A GUI such as that depicted in FIG. 15 may be presented to a peer. Any number of peers may receive a notification. A peer may be offered an opportunity to select a communication service which is used to contact a user. An image, audio and/or video of a user may be presented to a peer. Information of any number of prior interactions may be presented to a peer. Control is passed to operation 1320 and process 1300 continues.

In operation 1320 acceptance is received from a peer. Acceptance by a peer may be based on an explicit action of a peer, such as selecting a response action, or rejecting a response. Acceptance of a peer may be based on any suitable action by a peer. A time-out may indicate that a peer has not accepted. Control is passed to operation 1325 and process 1300 continues.

In operation 1325 a communication channel is selected. A communication channel may be selected based on various factors. For example, a preferred communication channel of a user and/or a peer may be selected. A communication channel to which a user has previously responded may be selected. If more than one peer has responded, a channel associated with a highest rated or highest ranked peer may be selected. A communication channel which is not controlled by the distribution server may be selected. For example, an app of a peer device may be used to select a communication channel. Any number of channels may be selected. For example, channels associated with multiple peers may be selected if multiple peers respond. Control is passed to operation 1330 and process 1300 continues.

In operation 1330 an indication is delivered. An indication may include various information. An indication may include images, text, audio, Uniform Resource Locators, and/or links, etc. An indication may be delivered using any selected communication channel. For example, an image associated with a peer, content of a previous activity, a link to an activity such as a highly rated activity or activity including peers, etc. may be included in an indication. An indication may be delivered at any time. For example an indication may be delivered at a time when a user has previously participated in an activity. Control is passed to operation 1335 and process 1300 continues.

In operation 1335, process information is recorded. Information of a request, a user, a responder, a publisher, a website, an advertiser, content, targeting parameters, user actions, an indication, peers, user responses to an indication, time, etc., a rating, a ranking, etc. of an item may be recorded or persisted. In at least one embodiment, process information is recorded in the database 1120 (FIG. 11). Control is passed to operation 1305 and process 1300 continues.

An exemplary User Interface for providing profile information and associations 1400 is illustrated with respect to FIG. 14. The profile GUI 1400 may be presented using a device such as the user system 1110 (FIG. 11). The Profile GUI 1400 may include a navigation control 1405, a storage control 1410, a communication channel indicator 1415, a username indicator 1420, a display name indicator 1425, user avatar indicators 1430a-1430b, a device address indicator 1435, a date of birth indicator 1445, a gender indicator 1450, a biography indicator 1455, a geographic information indicator 1460, and peer information controls 1465a-1465c.

The navigation control 1405 may be used to navigate to other user interfaces. The storage control 1410 may be used to indicate that information provided using the GUI 1400 is to be recorded. The communication channel indicator 1415 may be used to indicate a communication channel associated with a user. While a single communication channel indicator is illustrated in FIG. 14, any number of communication channel indicators may be provided. Communication channel information may be obtained using access information provided by a user device such as the user system 1110. The username indicator 1420 may be used to provide information of a user which may be used to uniquely identify a particular user. The screen name indicator 1425 may be used to provide information of a display name which may or may not be unique to a user. The user avatar indicator 1430a may be used to provide information of an image associated with a user. For example, activation of the user avatar indicator 1430a may allow a user to select an image which may be displayed to identify a user and/or an activity of a user. The user avatar indicator 1430b may be used to indicate that an image indicated in the user avatar indicator 1430a is to be removed.

The device address indicator 1440 may be used to provide information of a wireless service. For example, a subscriber ID or phone number which may be used to transmit a message such as an indicator or a notification may be indicated in the device address indicator 1440. Any number of identifiers may be provided in the device address indicator 1440. The date of birth indicator 1445 may be used to indicate date of birth information. The gender indicator 1450 may be used to indicate gender of a user. The biography indicator 1455 may be used to provide information of interests and/or other user information. The geographic information indicator 1460 may be used to provide geographic information such as a postal code, GPS data, postal address, etc. The peer information controls 1465a and 1465b may be used to send invitations to persons associated with a user via a social network or other connection database. If users identified by a service are registered with the distribution server 1130 (FIG. 11) that status may be indicated to a user when invitations are sent. The peer information control 1465c may be used to assist a user in locating acquaintances using a search index provided by the distribution server 1130. Any or all items indicated in the Profile GUI 1400 may be obtained from a user device and/or a database accessible to the distribution server 1130.

An exemplary User Interface 1500 for providing a notification to a peer is illustrated with respect to FIG. 15. The notification GUI 1500 may be presented using a device such as the user system 1110 (FIG. 11). The notification GUI 1500 may include a message area 1505, a peer indicator 1510, a user indicator 1515, and messaging channel consent indicators 1520a-1520e.

The message area 1505 may include any type of media which can be delivered to a peer. The message area 1505 may be a screen provided in an application resident on a user device such as the user device 1105. The peer indicator 1510 may include information of a peer such as an avatar. The user indicator 1515 may include information of a user who may receive an indicator message from a person operating the GUI 1500. The messaging channel consent indicators 1520a-1520e may be used to indicate whether an indicator or message is to be provided to a user indicated by the user indicator 1515 using information of a peer indicated by the user indicator 1510. Consent may be indicated in any suitable manner. For example, the filled circle in the messaging consent indicator 1520b may be used to indicate that an email message may be sent using an email service indicator of a peer indicated by the peer indicator 1510 to a user indicated by the user indicator 1515. For example, if the messaging channel consent indicator 1520a is activated a messaging client resident on the user device 1105 may send an SMS or MMS message to a subscriber ID provided by the user indicated in the user indicator 1515. The messaging consent indicator 1520e may be used to decline to send an indication or notification or message. Any number of messaging channel indicators may be presented and/or selected based on communication channels shared by a user and a peer.

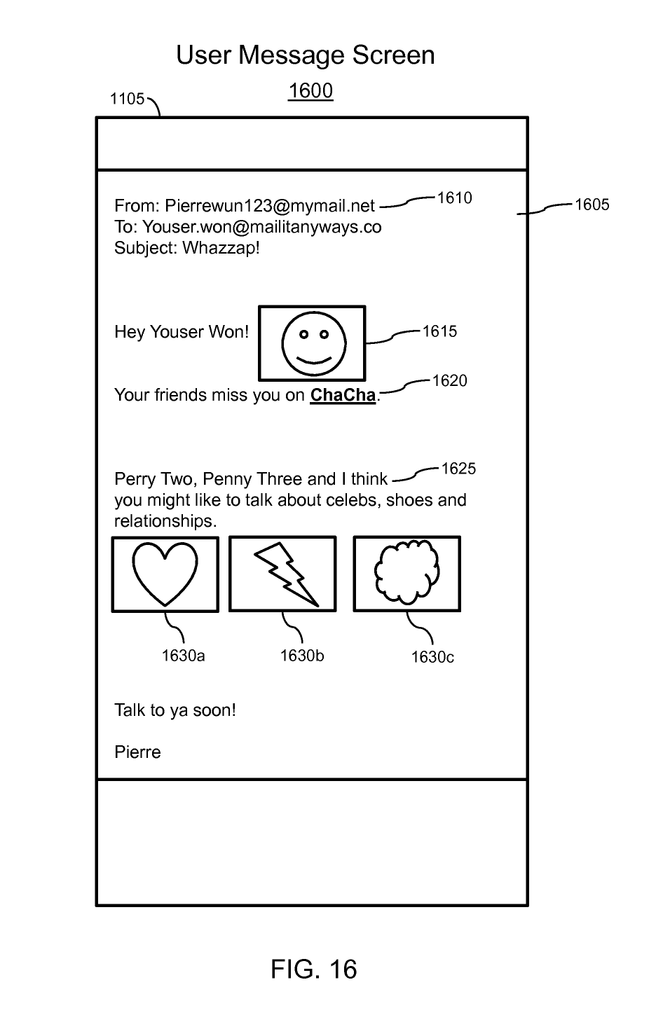

An exemplary User Interface 1600 for providing an indicator or message requesting participation in an activity to a user is illustrated with respect to FIG. 16. The indicator GUI 1600 may be presented using a device such as the user system 1105 (FIG. 11). The indicator GUI 1600 may include an indicator message area 1605, a message header indicator 1610, a user indicator 1615, a login link 1620, a peer activity indicator 1625, and peer indicators 1630a-1630c.

The indicator message area 1605 may include any type of media which can be delivered to a peer. The indicator message area 1605 may be a screen provided in an application resident on a user device such as the user device 1105. For example, an email, messaging, IM, or other app may provide the indicator GUI 1600. The message header indicator 1610 may include information of a communication channel shared by a user and a peer. For example, an originating and target subscriber ID, email address, etc., may be indicated as per a protocol of a messaging service utilized. The user indicator 1615 may include information of a user who may receive an indicator message. For example, an avatar and a screen name provided by a user may be displayed in the user indicator 1615. The login link 1620 may direct a user to a login or landing screen of an App which may be resident on the user system 1105. The peer activity indicator 1625 may indicate information associated with activities of a user. For example, if a user has previously participated in an activity, an indicator of the activity may be provided in the peer activity indicator 1625. Links to previous activities which may have been selected for a user may be indicated in the peer activity indicator 1625. The peer indicators 1630a-1630c may be used to provide information of peers. For example, the peer indicator 1630a may include information of a peer which originated a message indicated in the indicator message are 1605. Activation of a peer indicator may direct a user to a profile of an indicated peer such as the Profile GUI 1400 (FIG. 14).

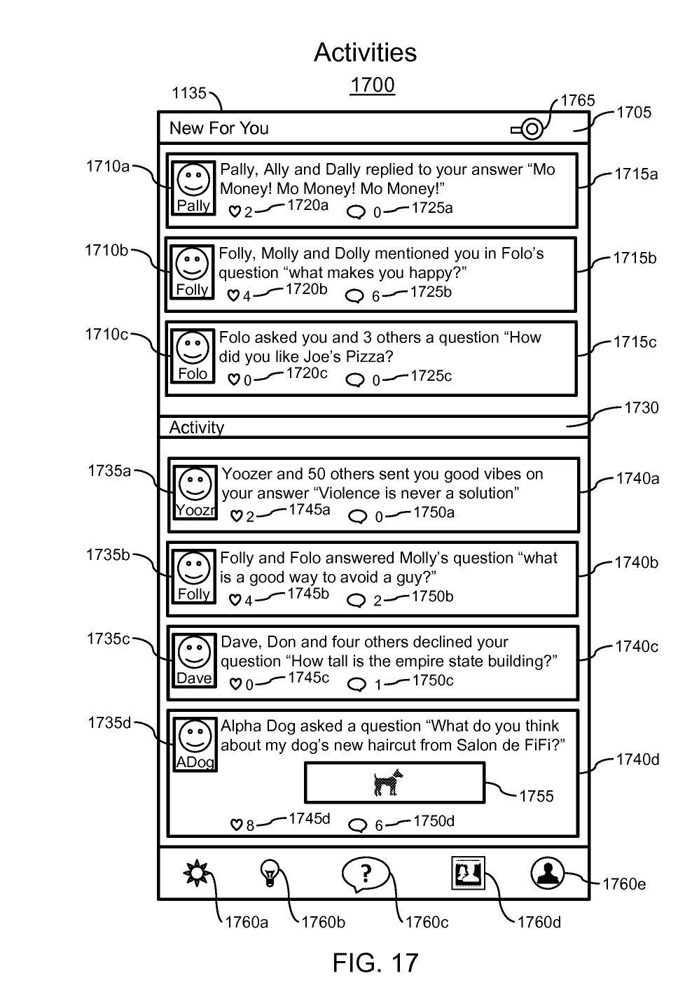

An exemplary activity GUI 1700 for presentation of requests is illustrated in FIG. 17. The activity GUI 1700 may be provided using a device such as the responder system 1135 (FIG. 11). The activity GUI 1700 may be presented responsive to activation of a control provided for that purpose. The activity GUI 1700 may include a selected response area 1705, selected request indicators 1715a-c, a raw request area 1730, raw request indicators 1740a-d, interface selection controls 1760a-e, and a request filter control 1765.

The selected request area 1705 may be used to provide information of requests which have been chosen based on explicit and/or implicit criteria and/or filtering. For example, if a responder has chosen to view only requests with activity in the last 24 hours, those requests might be presented in the selected response area 1705. The selected request indicators 1715a-1715c may be used to indicate information of selected requests. For example the selected request indicator 1715b provides information regarding the request “what makes you happy”. Selected request requester indicators 1710a-c, may be used to provide information of a requester associated with a selected request. For example, the selected request requester indicator 1710a may indicate that ‘Pally’ has submitted a reply to a response of a user of the GUI 1700. Selected request opinion indicators 1720a-1720c may be used to indicate information of opinions associated with a selected request. For example, the selected request opinion indicator 1720a may indicate that two user have expressed a positive opinion regarding the request indicated in the selected request indicator 1715a. Selected request reply indicators 1725a-1725c may be used to indicate information of responses associated with a selected request. For example, the selected request reply indicator 1720c may indicate that no users have provided a reply regarding the request indicated in the selected request indicator 1715a.

The raw response area 1730 may be used to provide information of requests which have been chosen based on limited criteria. For example any request which has received activity may be presented in the raw response area 1730 in chronological order. The raw request indicators 1740a-1740d may be used to indicate information of raw requests. For example the raw request indicator 1740a provides information regarding the request with a response “Violence is never a solution”. Raw request requester indicators 1735a-1735d may be used to provide information of a requester associated with a selected request. For example, the raw request requester indicator 1735b may indicate that ‘Folly’ has submitted a reply to the request “what is a good way to avoid a guy”. Raw request opinion indicators 1745a-1745c may be used to indicate information of opinions associated with a raw request. For example, the raw request opinion indicator 1745d may indicate that eight user have expressed a positive opinion regarding the request indicated in the selected request indicator 1740d. Raw request reply indicators 1750a-1750d may be used to indicate information of responses associated with a raw request. For example, the raw request reply indicator 1720c may indicate that one user has provided a reply regarding the request indicated in the raw request indicator 1740c.

A user may be able to navigate through content of the selected request area 1705 and/or the raw response area 1730, which may include a media window 1755. If the media window 1755 is present, presentation of content of the media window 1755 may automatically be initiated in an order in which the media window 1755 appears. Content of the selected request area 1705 and/or the raw response area 1730 may be removed and/or scrolled after playback is completed. For example items might be removed by ‘swiping’ and/or other gestures.

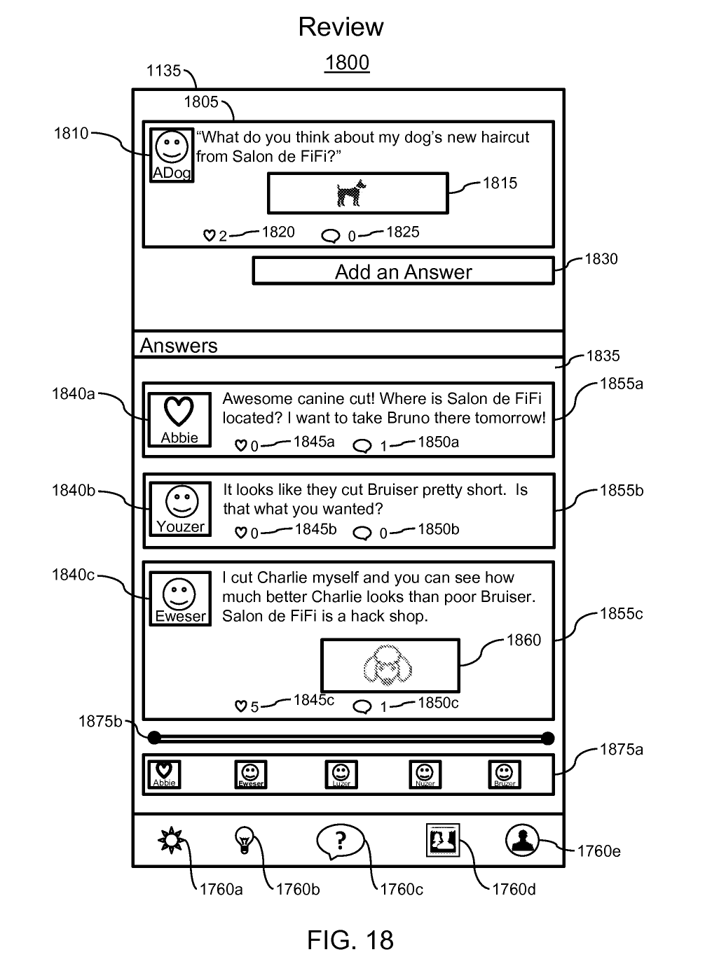

The interface selection controls 1760a-1760e may be used to select a user interface. Activation of the interface selection control 1760b may cause a GUI such as that depicted in FIG. 18 to be provided. Activation of the interface selection control 1760c may cause a GUI for submission of a request (not shown) to be provided. Activation of the interface selection control 1760d may cause the GUI 1700 to be provided. Activation of the interface selection control 1760e may cause a GUI such as that depicted in FIG. 14 to be provided. Any number of interface selection controls may be provided and or suppressed as required to operate the embodiments. The request filter control 1765 may be used to select a request based on criteria such as a user name, user group, keyword, hashtag, etc.

An exemplary viewing GUI 1800 for presentation of responses is illustrated in FIG. 18. The reviewing GUI 1800 may be provided using a device such as the responder system 1135 (FIG. 11). The reviewing GUI 1800 may be presented responsive to activation of a control provided for that purpose. The reviewing GUI 1800 may include a request information area 1805, selected response indicator area 1835, and response presentation controls 1875a-1875d.

The request information area 1805 may include a request user indicator 1810 which may provide information of a user associated with a request, a request media indicator 1815 which may comprise information of media associated with a request, a request opinion indicator 1820 which may indicate opinions associated with a request, and a request response indicator 1825 which may be used to indicate information of a response or answer associated with a request. A number of responses, a number of unviewed responses, etc. may be indicated using any suitable means such as color underlining, etc. Activation of a request opinion indicator may increase or decrease a count of opinions of a request. Activation of a request response indicator may provide an interface for responding to a request.

The selected response indication area 1835 may include selected response indicators 1855a-1855c which may indicate content of a response or reply. Content of selected response indicators may be determined by a process such as that described herein with respect to FIG. 13. Selected response user indicators 1840a-1840c may indicate information of a user associated with a response. Selected response opinion indicators 1845a-1845c may be used to indicate information of opinions associated with a response. Selected response reply indicators 1850a-1850c may be used to indicate information of answers or replies associated with a response. The selected response indication area may include a response media indicator 1860. When the response media indicator 1860 is presented in the selected response indication area 1835 playback of media associated with the response media indicator 1860 may be initiated and/or added to a queue for playback.

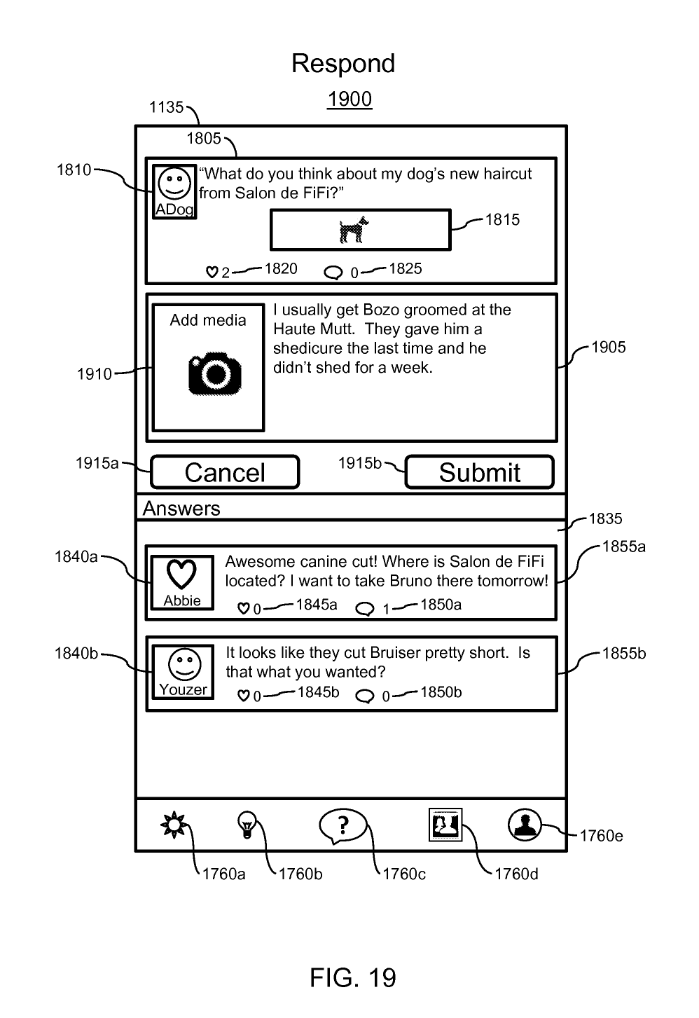

The response presentation controls 1875a-1875b may be used to access content of responses. For example, ‘thumbnails’ of a responder associated with a response may be provided which may permit non-linear access to content of responses without scrolling in the response presentation control 1875a. Similarly a ‘slider’ control may be provided to permit rapid visual search of content of responses without scrolling or swiping as in the response presentation control 1875b. Activation of a response presentation control may provide preview information of responses and/or may permit a change of playback sequence. Media of a response may be converted from static to dynamic form such as conversion of audio to text for purposes of playback. Any content associated with a response may be included in a playback sequence. Activation of the answer control 1830 and/or the response indicators 1855a-1855c may cause a GUI such as the GUI 1600 depicted in FIG. 19 to be provided.

An exemplary response GUI 1900 for responding to a request is illustrated in FIG. 19. The response GUI 1900 may be provided using a device such as the responder system 1140 (FIG. 11). The response GUI 1900 may be presented responsive to activation of a control provided for that purpose. The response GUI 1900 may include the request information area 1805, the selected response indicator area 1835, the interface selection controls 1760a-1760e, a response indicator 1905, a response media indicator 1910, and response submission controls 1915a-1915b.

The response indicator 1905 may be used to provide textual information regarding a response. The response media indicator 1910 may be used to provide information of media such as audio, video, images, etc. associated with a response. The response submission control 1915a may be used to cancel a response. The response submission control 1915b may be used to submit a response associated with a request and/or an answer.

The interfaces described may be used to allow interactions between users, however, any types of activities between users and peers might be used to determine actions of user and interactions between a user and a peer.

Using the method and systems described herein a message inviting a user to return to activity with a network or “indication” is provided. A user may register with a distribution server which may obtain information of associations between a user and peers. Association information may be obtained from a user device, from a database associated with other organizations and/or networks to which a user belongs, etc. Communications information which can be used to direct a message from a user to a peer may be obtained. Information of interactions between a user and peer may be recorded.

If a user has been determined to be inactive based on a time interval since a last activity and/or other criteria a number of peers may be selected. Peers may be selected based on association strengths determined to exist between a user and a peer. A number of peers may receive a notification message which invites a peer to deliver an indication to a user. If a user consents an indication of a peer may be delivered to a user. A communication channel which excludes a distribution system and/or is a peer to peer communication may be used to deliver an indicator to a user. An indicator may include information of peers who may have responded to a notification. An indicator may provide information of activities of peers to a user.

A system and method of providing a message to an inactive user using peer to peer communication is implemented. If a user is determined to be inactive, peers are selected based on associations and historical activities involving a peer and a user. An indication message is delivered to a user based on consent and communications information associated with a user and a peer.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of providing media comprising:
receiving a request comprising content;
performing a search of media files based on the content;
providing indicators of a number of the media files ranked highest for the request;
receiving a selection of a media file of the media files; and
presenting the media file in association with the content and an identifier of a composer of the request.

2. The method of claim 1 wherein the media files are images further comprising:
presenting a portion of text indicated by the content as a query to a search facility; and
ranking the media files based on the text when a user confirms the query.

3. The method of claim 1 wherein the media files are images further comprising:
creating a query from the content based on keywords associated with the media files and a ranking of the keywords; and
performing the search based on the query.

4. The method of claim 3 further comprising:
selecting the keywords based on a category associated with the request; and
ranking the keywords based on a source of a post for which the request is a reply.

5. The method of claim 1 further comprising:
selecting a query based on metadata associated with the request; and
determining the metadata based on a posting associated with the request.

6. The method of claim 5 further comprising:
determining the metadata based on responses associated with the posting and the request.

7. The method of claim 1 further comprising:
selecting a query based on a category assigned to a posting to which the request is a response; and
ranking the media files based on the category and the content.

8. The method of claim 1 further comprising:
selecting a query based on a history of media files selected by a source of the request; and
ranking the media files based on the query.

9. The method of claim 1 further comprising:
ranking the media files based on previous selections of media files;
receiving the previous selections from sources performing searches comprising a portion of the content.

10. The method of claim 1 further comprising:
ranking the media files based on previous selections of media files;
receiving the previous selections from sources submitting a query created based on the content.

11. The method of claim 1 further comprising:
creating a query based on the content;
presenting queries created from the content in an order based on a ranking of the queries; and
executing the search based on the query when a source of the request confirms the query.

12. The method of claim 1 further comprising:
obtaining a reply to a posting for which the request is a response;
determining a query based on the reply, the posting and the request; and
performing the search based on the query.

13. The method of claim 1 further comprising:
selecting the media files from a device associated with a source of the request.

14. The method of claim 1 further comprising:
selecting the media files from a library determined based on an intended distribution of a posting.

15. The method of claim 1 further comprising:
ranking the media files based on a source of the media files;
obtaining a link between a source of the request and a peer;
delivering an indication to the peer based on consent of the source and an interaction history of the peer and the source; and
sending a notification to the source based on a response of the peer to the indication.

16. The method of claim 1 further comprising:
presenting the media file when a response is selected based on a source of the request and a source of a posting to which the request responds.

17. The method of claim 1 further comprising:
creating a search query based on a search result obtained by submitting a portion of the request to a search engine.

18. A system for providing media comprising:
a server device receiving a request comprising content, performing a search of media files based on the content, providing indicators of a number of the media files ranked highest for the request, receiving a selection of a media file of the media files; and presenting the media file in association with the content and an identifier of a composer of the request.

19. A non-transitory computer readable storage medium storing therein a program for causing a computer to execute an operation comprising:
receiving a request comprising content;
performing a search of media files based on the content;
providing indicators of a number of the media files ranked highest for the request;
receiving a selection of a media file of the media files; and
presenting the media file in association with the content and an identifier of a composer of the request.

20. The non-transitory computer readable storage medium of claim 19 wherein the operation further comprises:
preferentially directing a query based on the request to a search resource based on a cost associated with distribution of the media files.
